(19) United States
(12) Patent Application Publication
(10) Pub. No.: US 2009/0234680 A1
(43) Pub. Date: Sep. 17, 2009

(54) SECURITIZATION OF PRE-PAID CONFERENCE AND REGISTRATION FEES IDEA

(76) Inventor: DALE C. NEWTON, Kissimmee, FL (US)

Correspondence Address: BROWN RUDNICK LLP, ONE FINANCIAL CENTER, BOSTON, MA, 02111, US

(21) Appl. No.: 12/404,756

(22) Filed: Mar. 16, 2009

Related U.S. Application Data
(60) Provisional application No. 61/036,531, filed on Mar. 14, 2008.

(51) Int. Cl. G06Q 40/00; G06Q 10/00; G06Q 50/00

(52) U.S. Cl. 705/5; 705/37

(57) ABSTRACT

A method for the securitization of pre-paid fees for an event is presented. The method includes the steps of registering for at least one event through an interactive medium and a non-interactive medium; providing financial and non-financial information relating to the at least one event; submitting a prepaid fee as a payment to register for the at least one event; processing the payment into at least one cash flow; and utilizing the at least one cash flow to create a special purpose vehicle as collateral to issue and sell at least one bond. A method for securitizing cash flows associated with the payment of airline tickets and a method for offsetting event-related attrition based upon financial and non-financial information are also presented.

### CROSS-REFERENCE TO RELATED APPLICATIONS

This patent application claims priority to U.S. Provisional Application Ser. No. 61/036,531, filed in the U.S. Patent and Trademark Office (USPTO) on Mar. 14, 2008 by Dale C. Newton, the entire contents of that application being incorporated herein by reference in its entirety.

### BACKGROUND

1. Technical Field

The present disclosure generally relates to the field of asset class securitization, and more particularly, to the securitization of pre-paid fees made in association with a scheduled event.

2. Description of the Related Art

The typical steps that a conference organizer, event host, meeting planner, or organizer takes who has the primary responsibility for a scheduled meeting or event is well known in the art. Depending on the type of meeting/event and the category of the scheduled meeting/event, an entity may choose to retain and hire an outside meeting planner or use an in-house meeting planner to handle the job.

For example, an organization may make the decision to retain and hire the services of an outside certified meeting planner for its upcoming event, entitled “Electronic Toys 10th Annual Convention” and that the event will be held 5-9 Jan. 2009 at a venue in New York. After being retained, the meeting planner first obtains as much information as possible and a thorough understanding of what the client wants and expects from the event and then prepares a detailed plan for the event.

The meeting planner then uses the plan and prepares a budget based on the current meeting, past historical meetings data, or may simply be given a fixed budget amount to work with. The meeting planner then designs, organizes, negotiates, manages, and coordinates execution of the plan using different subcontractors who can provide and meet the specific needs and logistical requirements for the meeting/event within his/her budget.

The attendees, participants, sponsors, exhibitors, speakers, guests, and news media are sent registration packets via US mail or they may go to the conference website and complete an application on-line via the Internet. Usually the meeting planner has an estimate of the number of attendees that are expected and is given a budget (i.e. less than $1 Million dollars) in order to ensure that all fixed and variable costs and meeting/event related expenses will be covered. Income from the meeting/event is received in the form of advance prepaid registration and conference fees paid by the attendees, participants, speakers, guests, presenters, and exhibitors. During the online registration process, the appropriate conference and registration fees, sponsor fees, exhibitor fees and any other fee (i.e. advance hotel deposit, special dinner event, tour, workshop, etc.) and payment information is usually provided on a webpage, as well as the acceptable means of payment using a credit card, a debit card, money transfer, etc. Additional meeting-related income is obtained from selling and receiving deposits for advertising space in the official meeting program guide from meeting supporters, obtaining funding via sponsorships, receiving advance prepaid fees concessions, selling of meeting-related publications/educational material, and interest income. After the completed meeting registration application has been processed and the payments cleared and settled, the participants and attendees receive notification that they may attend the scheduled meeting and any other associated special event.

The creation of a listing of scheduled current planned and future meetings and events is a well-known and established practice. This information is very useful for business organizations, academicians, professionals, the general public, and anyone who desires to keep up-to-date with the latest technology, trends, and information in their field of expertise, acquire new knowledge, maintain certain skills, develop new potential customers, etc. Typically, these meetings require an individual to complete a registration process in advance or to do so in person at the meeting site before they can attend any of the meeting functions and activities. Further, these meetings functions and activities typically provide a plurality of hobbies, interests, pursuits, activities, and personal and professional subject matters that attracts individuals to them. As a result, the demographic information of an individual may be obtained before, during, or after the registration process for a meeting that has been completed.

Although guests are often invited and welcome to attend a meeting/event, tradeshow, convention, or conference, for the most part, they tend to be either invited by a registered attendee, or they may be invited to attend as a guest speaker by the parent/host sponsor organization. Through a website, volunteers may be solicited to serve as “guest liaison” and assist and support the convention staff and are required to obtain their “own food, hotel room, transportation, and . . . badge”. However, there appears to be limited information regarding the potential significant role that guests can serve for the purposes of reducing, minimizing, or potentially eliminating room block and food-beverage consumption attrition risks.

In the airline industry, the current marketplace approach for customers, such as those registering for a meeting or event, to book their airline ticketing and meet their travel needs seems to focus on customers chasing prices offered by different airlines. Mid-market companies, defined as those with $2 million to $12 million in U.S. booked air volume, have potential savings to manage their travel that can exceed hundreds of thousands of dollars. Many companies that spend less than $2 million in U.S. booked air, or $4 million in U.S. travel and entertainment, successfully manage travel spending, but they face different challenges and opportunities than their higher spending colleagues.

Most industry experts agree that small and mid-market companies constitute a significant portion of the business travel landscape, yet many travel managers in those tiers view themselves as overlooked. A lot of agencies looked at the small and mid-market for a long time, but they've discovered that while in aggregate it's a gigantic market, companies of that size generally deal with small amounts of spend, and are not as aggressively managing it.

The airlines are trying to reduce the cost of managing smaller companies. Since achieving discounts has become increasingly difficult for companies with U.S. booked air volumes shy of $12 million, many travel managers in the mid-market segment have found other ways to mitigate climbing air costs. Several mid-market travel buyers are considering the use of alternative airports to take advantage of better fare environments, while others have heavily pushed advance-purchase policies or lowest-logical-airfare policies.

Consolidator fares are discount airline tickets purchased by “airline wholesalers” and then resold to travel agencies at substantial discounts (up to 70% off regular fares). Consolidators are companies that negotiate with airlines to buy up seats that would otherwise not be sold (a type of wholesaler). The tickets sold by consolidators are primarily for international flights, but there are many available for domestic flights as well. Consolidators buy in large volumes, so they can offer their tickets for substantially less than normal published fares. Because these are tickets purchased from consolidators, not from the airlines, flight availability changes constantly and tickets are first come, first served. Most consolidators reserve nine (9) seats per flight per contract, so it does not take much for seats on a particular flight to sell out. In essence, airline ticket consolidators are ticket distribution companies that negotiate with airlines to buy up unsold seats, primarily on international flights, at bargain rates. Because they buy in large volumes, consolidators can offer these tickets for substantially less than normal discount fares.

In the competitive commercial passenger airline market, different airlines have different operating expenses and costs, daily available seat miles (ASMs) and revenue passenger miles (RPMs) quotas to meet, financial goals and business objectives. They typically price their airline tickets taking some of these factors into account.

The traditional model involves the customer going to one or more travel related or company-specific airline websites (i.e. Travelocity.com., Delta.com, etc) and entering certain demographic data and travel information and making an on-line payment using a credit or debit card:

1. desired departure and return dates of travel;

2. number of individuals traveling (i.e. adult, children, seniors, etc);

3. departure city and State;

4. arrival city and State;

5. desired time of departure;

6. desired time to return; and

7. type of fare (i.e. coach, business-first class).

A list of potential available airlines that meet the traveler's needs is generated along with each airline's respective ticket price per passenger. The customer then uses a credit or debit card to make their payment online, receives a confirmation notice, and is able to print an electronic boarding ticket for that airline.

The concept of a “reverse auction” (also called procurement auction, e-auction, sourcing event, e-sourcing or eRA) is a tool typically used in industrial business-to-business procurement. A reverse auction is a type of auction in which the role of the buyer and seller are reversed, with the primary objective to drive purchase prices downward. In an ordinary auction (also known as a forward auction), buyers compete to obtain a good or service. In a reverse auction, sellers compete to obtain business.

A reverse auction is a strategy used by many purchasing and supply management organizations for spend management, as part of strategic sourcing and overall supply management activities. In a typical auction, the seller puts an item up for sale. Multiple buyers bid for the item, and one or more of the highest bidders buy the goods at a price determined at the conclusion of the bidding. In a reverse auction, a buyer contracts with a market maker to help make the necessary preparations to conduct the reverse auction. This includes finding new suppliers, training new and incumbent suppliers, organizing the auction, managing the auction event, and providing auction data to buyers to facilitate decision making.

The market maker, on behalf of the buyer, issues a request for quotation (RFQ) to purchase a particular item or group of items (called a “lot”). At the designated day and time, several suppliers, typically 5-20, log on to the auction site and will input several quotes over a 30-90 minute period. These quotes reflect the prices at which they are willing to supply the requested good or service.

Quoting performed in real-time via the Internet results in dynamic bidding. This helps achieve rapid downward price pressure that is not normally attainable using traditional static 3-quote paper-based bidding processes.

The prices that buyers obtain in the reverse auction reflect the narrow market which it created at the moment in time when the auction is held. Thus, it is possible that better value (i.e. lower prices, as well as better quality, delivery performance, technical capabilities, etc.) could be obtained from suppliers not engaged in the bidding or by other means such as collaborative cost management and joint process improvement.

The buyer may award contracts to the supplier who bid the lowest price. Alternatively, a buyer could award contracts to suppliers who bid higher prices depending upon the buyer's specific needs with regards to quality, lead-time, capacity, or other value-adding capabilities. However, buyers frequently award contracts to incumbent (i.e. current) suppliers, even if prices are higher than the lowest bids, because the switching costs to move work to a new supplier are higher than the potential savings that can be realized. This outcome, while very attractive to buyers, is often strongly criticized by both new and incumbent suppliers.

The use of optimization software has become popular since approximately 2002 to help buyers determine which supplier to source the work to. It includes relevant buyer and seller business data, including constraints.

Reverse auctions are used to fill both large and small value contracts for public and private commercial organizations. In addition to items traditionally thought of as commodities, reverse auctions are also used to source buyer-designed goods and services, and has even been used to source reverse auction providers. The first time this occurred was in August 2001, by America West Airlines (now US Airways) using FreeMarkets software and won by MaterialNet.

The majority of purchasing spend subject to reverse auctions over the years has been in the category of buyer-designed goods, followed by services, and then commodity items. Today, an average of five percent (5%) of total corporate spending is sourced using reverse auctions. This figure was higher in past years, indicating the goods and services to which reverse auctions can be successfully applied is limited.

Buyers, sellers, and market makers should adhere to auction rules and industry codes of conduct for the use of reverse auctions, if they exist. Problems arise when one or more parties fail to conform to auction rules. This can range from simple cries of “foul” to litigation.

Buyers should not assume that reverse auctions will, in every case, deliver savings, either on a unit price or total cost basis. Reverse auction savings can range from negative (i.e. it costs the buyer money) to neutral (i.e. no savings) to positive savings (average gross of ten to twenty percent (10-20%), but net savings is typically half or less).

Suppliers are advised to determine if a value proposition exists for them that would warrant their participation. Some have characterized reverse auctions as a technologically-assisted form of zero-sum power-based bargaining, or as “going in reverse” with respect to developing buyer-seller relationships, collaboration, and purchasing process improvement. Reverse auctions have also been criticized as “bid shopping” when a buyer uses a supplier's bid to obtain lower prices from other suppliers.

Suppliers seeking to avoid reverse auctions can create unique intellectual property, expand the value propositions for its customers by creating new products and services, or seek to extend or improve collaborative activities with their customers.

Reverse auctions (also becoming known as service auctions) are undergoing a resurgence at present, as evidenced by a number of service auction sites for freelancers (e.g. eLance.com, guru.com) that are doing a significant volume of business both in number of projects and amount of money spent (20,000 projects in the last 30 days and over $100 million spent since 2006).

The concept of securitization of credit card receivables with regard to the foregoing industries is well known in the art. From an investor's point of view, since credit card balances may tend to be paid off quicker than the average repayment period, it is desirable to have a credit card securitization structure that creates securities that have a longer life span. This is usually best achieved by splitting the receivable into two payment streams (i.e. principal and finance charges) so that the coupon on the security is paid off using the finance charges and the principal is repaid using either a revolving method or a controlled repayment methods. In addition, in order to achieve a higher investment grade rating for the issuance, credit enhancement is also typically incorporated as part of a securitization structure.

For very large organizations that have financing needs, a commercial paper program can be created in order to provide more cost effective management of their credit card receivables as well as reducing the organization's dependence on a bank line of credit. By controlling the amount of commercial paper outstanding, the organization can adjust for any adverse changes in its volume of credit card receivables, and thus use the savings generated by the paper in other ways to support the organization. These structures, however, are not directed towards unique asset class categories, which are useful for the purposes of securitization.

### SUMMARY

According to an aspect of the present disclosure, a method for securitizing pre-paid fees for an event is presented. The method includes the steps of registering for at least one event through an interactive medium and a non-interactive medium; providing financial and non-financial information relating to the at least one event; submitting a prepaid fee as a payment to register for the at least one event; processing the payment into at least one cash flow; and utilizing the at least one cash flow to create a special purpose vehicle as collateral to issue and sell at least one bond.

According to another aspect of the present disclosure, a method for offsetting event-related attrition based upon financial and non-financial information is presented. The method includes the steps of providing financial and non-financial information via an interactive medium and a non-interactive medium; storing the financial and non-financial information in a database; creating at least one shared interest group based upon the financial and non-financial information; presenting each of the at least one shared interest groups to an event-related party; inviting at least one member of the at least one shared interest group to attend the at least one event based upon the financial and non-financial information; and offsetting event-related attrition based upon the result of inviting the at least one member.

According to yet another aspect of the present disclosure, a method for securitizing cash flows associated with the payment of airline tickets is presented. The method includes the steps of providing specified information, through an interactive medium, for air travel from a specified point of origin to a specified point of destination on a specified departure date at a specified departure time; aggregating the specified information into at least one shared interest group; submitting a prepaid fee as a first payment to register with the shared interest group; presenting each of the at least one shared interest groups to the at least one airline for the right to become the scheduled airline carrier for the at least one shared interest groups; receiving at least one offer from the at least one airline; determining the lowest at least one offer; accepting the lowest offer from the at least one airline; submitting a second payment to fulfill the difference between the offer and the first payment; processing the second payment into at least one cash flow; and utilizing the at least one cash flow to create a special purpose vehicle as collateral to issue and sell at least one bond.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a block diagram for the securitization of prepaid fees associated with events, according to the present disclosure;

FIG. 2 is another embodiment of a block diagram for the securitization of prepaid fees associated with events, according to the present disclosure;

FIG. 2A is an embodiment for the securitization of prepaid fees associated with events, according to the present disclosure;

FIG. 2B is an embodiment for the securitization of prepaid fees associated with events, according to the present disclosure;

FIG. 2C is yet another embodiment for the securitization of prepaid fees associated with events, according to the present disclosure;

FIG. 3 is another embodiment of a block diagram for the securitization of prepaid fees associated with events, according to the present disclosure;

FIG. 3A is another embodiment of a block diagram for the securitization of prepaid fees associated with events, according to the present disclosure;

FIG. 3B is an embodiment for the securitization of prepaid fees associated with events, according to the present disclosure;

FIG. 4 is another embodiment of a block diagram for the securitization of prepaid fees associated with events, according to the present disclosure;

FIG. 4A is an embodiment for the securitization of prepaid fees associated with events, according to the present disclosure;

FIG. 4B is another embodiment of a block diagram for the securitization of prepaid fees associated with events, according to the present disclosure;

FIG. 5 is an yet another embodiment for the securitization of prepaid fees associated with events, according to the present disclosure;

FIG. 5A is an embodiment for the securitization of prepaid fees associated with events, according to the present disclosure; and

FIG. 5B is an embodiment for the securitization of prepaid fees associated with events, according to the present disclosure.

### DETAILED DESCRIPTION OF EXEMPLARY EMBODIMENTS

The present disclosure generally relates to the field of asset class securitization, and more particularly, to the securitization of pre-paid fees made in association with a scheduled event.

In the discussion that follows, the terms “event” and “meeting” shall refer to any formal or informal gathering of individuals or entities. Examples of an event or a meeting may include, but are not limited to, conferences, tours, workshops, luncheons, dinners, and discussion panels. The term “interactive medium” shall refer to any electronic, digital, or printed media that allows for the active participation by the recipient. Examples of interactive media may include, but are not limited to, a computer, a software application, and an Internet website. The term “non-interactive medium” shall refer to any electronic, digital, or printed media that restricts the level of participation by the recipient. Examples of non-interactive interactive media may include, but are not limited to, a printed publication, a printed form, and an audio registration process.

Reference will now be made in detail to exemplary embodiments of the present disclosure, which are illustrated in the accompanying figures. The same reference numbers in different drawings may identify the same or similar elements. In addition, the following detailed description does not limit the present disclosure.

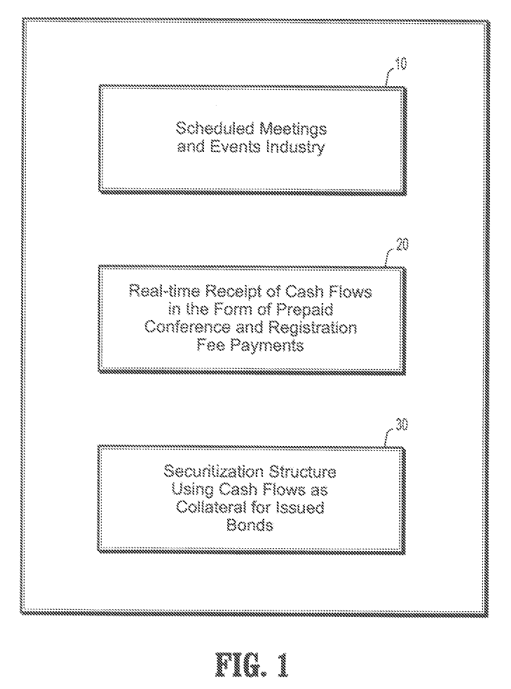

Referring to FIG. 1, a block diagram representing the securitization of prepaid fees associated with an event is presented. The block diagram depicts a scheduled meeting and event 10 industry and how cash flows that exist in the form of a prepaid conference and registration fee 20 associated with meeting/event 10 can be used as collateral for the purpose of a securitization 30 and the issuance of bonds.

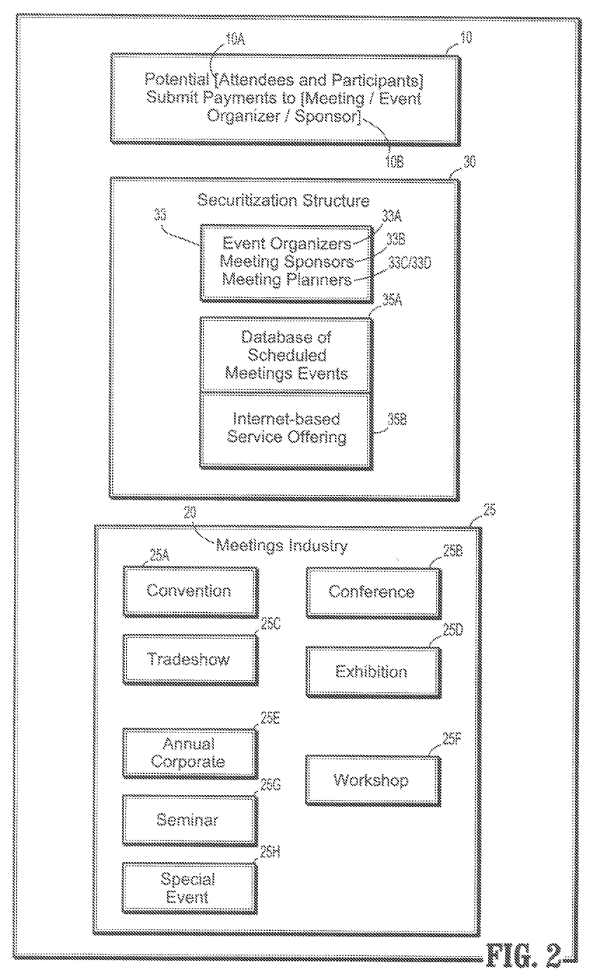

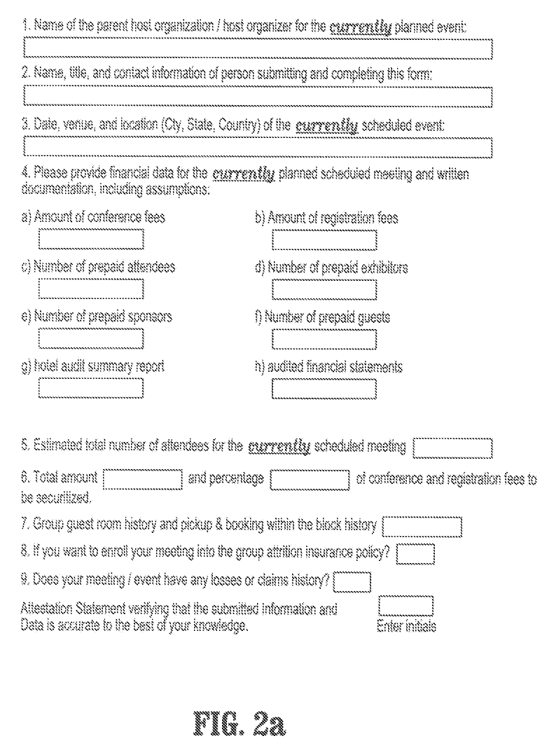

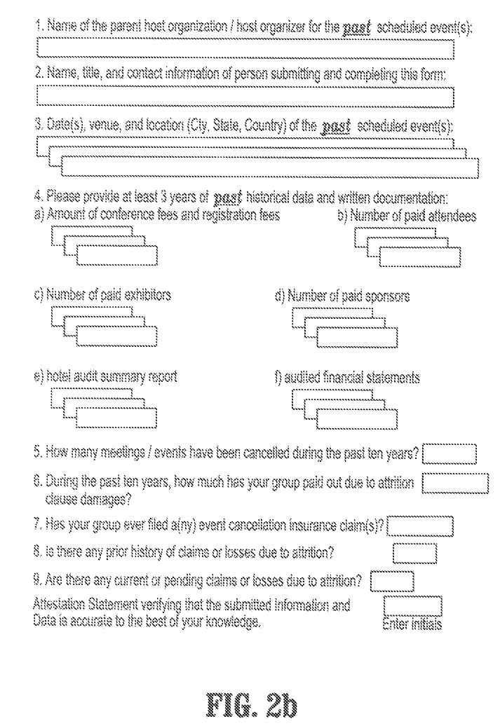

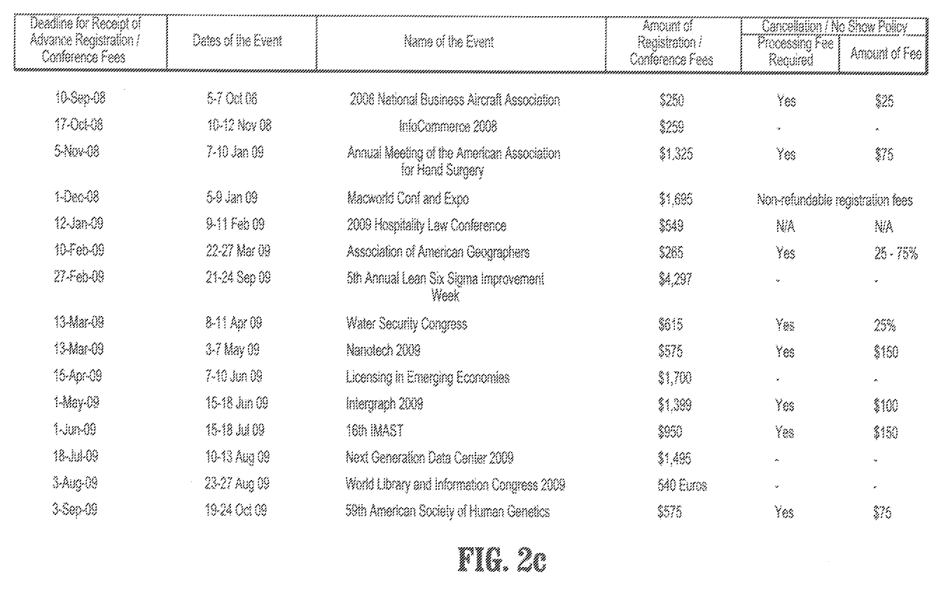

Referring to FIG. 2, another embodiment of a block diagram for the securitization of prepaid fees associated with events is presented. The block diagram depicts a cash flow payment 10 being linked with a meeting and event 20 industry via a securitization structure 30. In order to attend one of the current or a future scheduled meeting or event 20, cash flow payments 10 are usually prepaid and submitted by a potential meeting/event attendee(s) and participant(s) 10A, well in advance (i.e. weeks, months, years, etc.) of the scheduled meeting/event 20 using various types and different sources of payment mechanisms (i.e. debit or credit card, bank wire, money order, etc). The recipient of cash flow payments 10 is typically an event organizer/sponsor 10B that is associated with a particular industry (i.e. banking, automotive, pharmaceutical), subject matter (i.e. AIDS, global warming), trade (i.e. plumbing, cabinetmaking, X-ray Technician), professional discipline (i.e. law, medicine, engineering), cause (i.e. War on Poverty, Habitat for Humanity), religion (i.e. Catholic, Protestant), entity (i.e. Federal or State government), or function (i.e. Grammy Awards, Annual Dinner Banquet). The received cash flows 10 are then applied towards a current or future scheduled meeting/event 20.

Often, a parent host organization and/or host organizer 25 will engage the services of a certified meeting planner who has dedicated themselves to a specific industry and/or type of event/meeting 20 associated a particular industry, subject matter, trade, professional discipline, cause, religion, entity, or function. For example, a meeting planner may choose to only focus on “medical” meetings, “religious” meetings, “pharmaceutical” meetings, or “corporate” meetings. Thus, the term “meetings industry 20” is broadly defined to represent all types of subject matters, industries, trades, professional disciplines, vocations, scheduled events, etc. Besides these various subtypes of meeting planners, the cash flow payments 10 may be for a certain category or type of event/meeting 20 that the host recipient event organizer/sponsor 25 is supporting. For example, one can easily classify a plurality of event/meetings 20 based upon the following different specific categories of host organizations and organizers 25 (labeled as 25A thru 25H), including, but are not limited to:

25A - A Convention
25B - A Conference
25C - A Tradeshow
25D - An Exhibition
25E - An Annual corporate meeting
25F - A Workshop
25G - A Seminar
25H - A Special Event

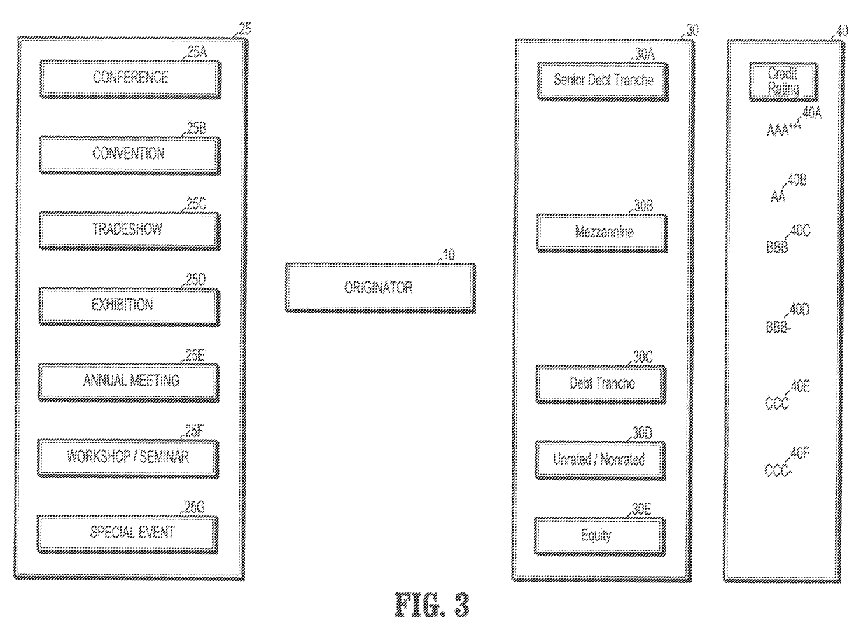

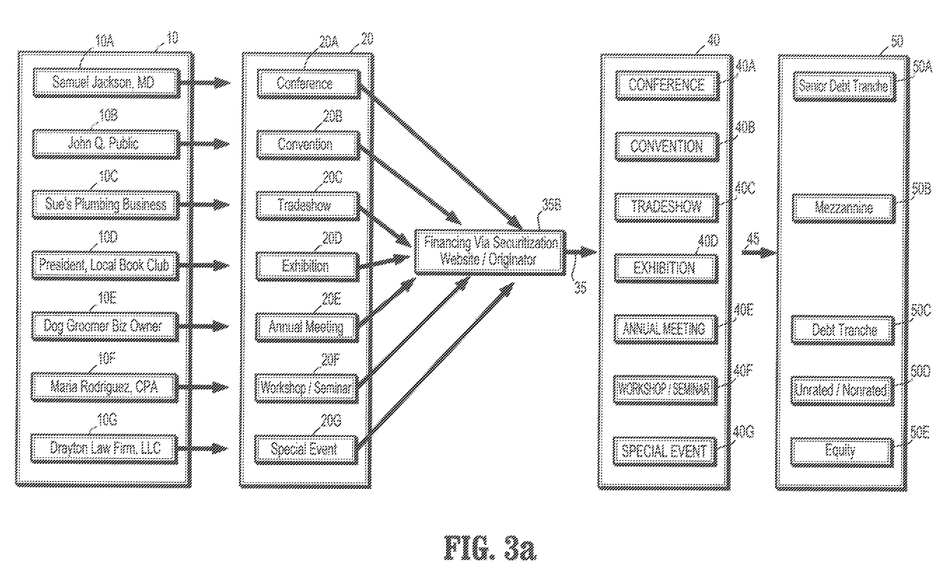

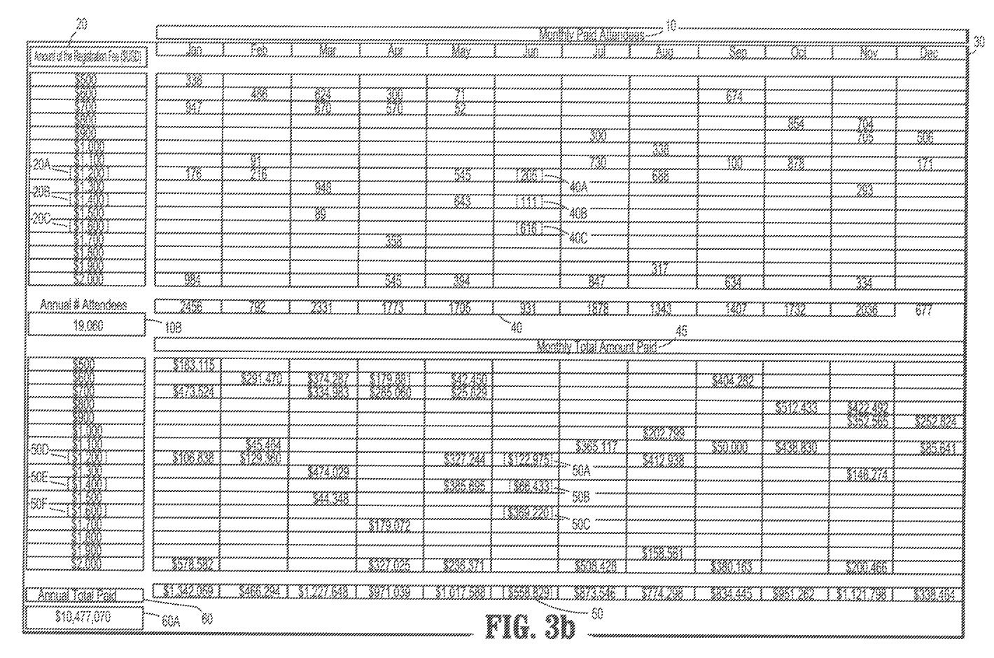

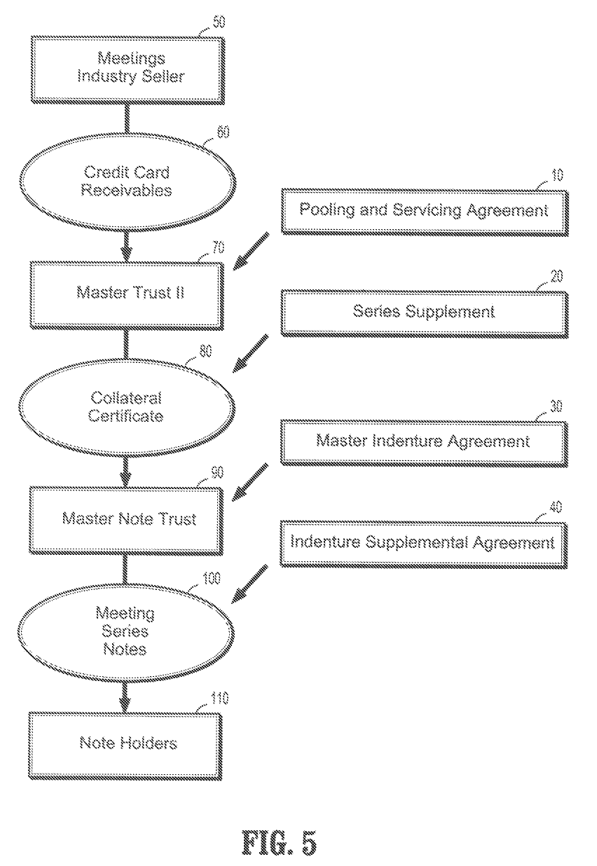

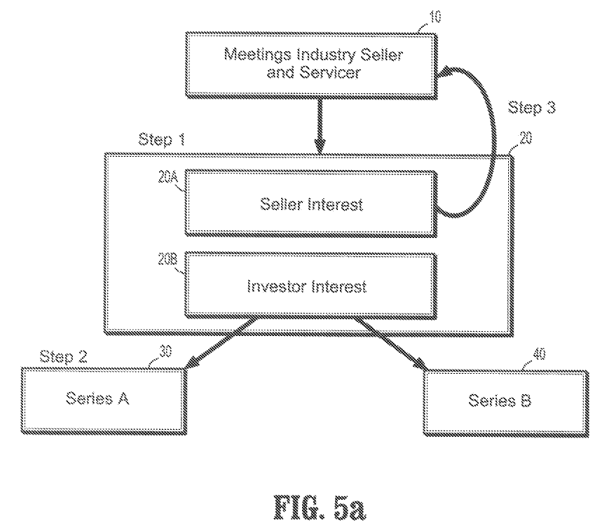

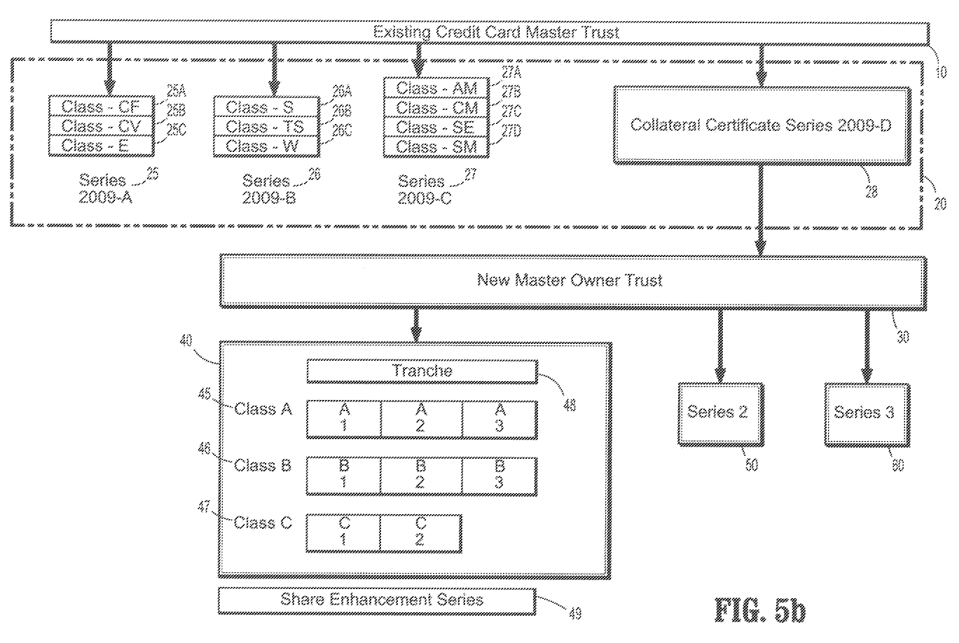

Securitization structure 30 that is shown linking meetings and events 20 industry with cash flows payments 10 will be separately described (FIGS. 3, 5A, and 5B) in greater detail. However, in general, FIG. 2 depicts securitization structure 30 consisting of one or more parent host organizations and/or host organizers 25 who may have their respective meeting(s) and event(s) 20 occurring separately, independently, jointly, simultaneously, during the same time frame, overlapping different time frames, or in the same or different geographic location(s). In an embodiment of the present disclosure, an entity 33 has the primary financial responsibility and overall administrative role for scheduled meeting or event 20 and may be either: an event organizer 33A, a meeting sponsor 33B, an in-house meeting planner 33C, or an outside meeting planner 33D who has been retained and hired by parent host organization and/or host organizer 25. A committee or a group of individuals who have been approved by parent host organization and/or host organizer 25 may also fulfill any of these designated roles.

In preferred embodiment of the present disclosure an individual or entity 33 plays an important role because they are responsible for submitting certain financial and non-financial data and historical information into a securitization database 35A of scheduled meetings and events 20 via an interactive medium, such as the Internet, or non-interactive medium, regarding one or more currently scheduled, previously completed, or future planned scheduled meeting(s) or event(s) 20.

Referring to FIG. 2A and FIG. 2B, embodiments of sample forms for the securitization of prepaid fees associated with events are presented. These forms would be completed and submitted by meeting planner via the website for purposes of securitization 30 of a future scheduled meeting or event 20, where “current” means within the next immediate twelve (12) months and “future” means a date more than or beyond the next immediate twelve (12) months.

The accuracy and integrity of the submitted data and information could result in an organization receiving or not receive financing via securitization 30 for their event/meeting 20. The submitted data and information initially undergoes a preliminary screening and review process.

If the initial submitted data and information meets certain pre-determined screening criteria that indicates that event or meeting 20 would be a favorable candidate for securitization 30, then a “favorable for securitization” response is provided back to the submitter. Otherwise, an “unfavorable for securitization” response is provided back to the submitter if the initial submitted data and information does not meet all of the pre-determined screening criteria. For those events and meetings 20 that receive a “favorable for securitization” preliminary response, a more in-depth review and analysis is conducted after requesting and receiving additional supporting written documentation from the submitter. With this additional information, further review and due diligence is performed by a team of key decision-makers who ultimately will decide whether to proceed or not to proceed with the securitization process of the submitted event 20.

For those events and meetings 20 receiving an “unfavorable for securitization” preliminary initial response, they would become eligible to have their submitted event 20 pooled with other potential candidate meetings and events 20. If the combination of these two potential meeting and event 20 candidates then meets the pre-determined screening criteria that indicates that their combined respective event or meeting 20 would receive a “favorable candidate for securitization” response, then this information is provided back to the respective submitters and they would be encourage to pursue a working relationship that would benefit each of their respective organizations on a pro-rata basis. Once these two organizations reach a mutual agreement, a more in-depth review and analysis of the combined meetings/events 20 is conducted after requesting and receiving additional written supporting written documentation from each submitter and their respective organization.

An integral part of securitization structure 30 is the securitization database 35A of scheduled meetings and events 20 because it contains entity 33 submitted critical financial and non-financial data and historical information about one or more current, previously completed, or future scheduled meeting(s) or event(s) 20. Securitization database 35A is scalable, redundant, has firewall and enhanced security features (i.e. password and data encryption protection), is dynamic, and is continuously updated with robust information and data that has been validated, authenticated, and verified so that it can be used by the key decision-makers who are intimately involved in the securitization 30 approval and monitoring process.

Referring now to FIG. 2C, yet another embodiment for the securitization of prepaid fees associated with events is presented. In an embodiment, a system may be implemented by using at least one or more digital computers, computer servers, computer databases, and creating a network to run one or more application software programs that results in the transformation of a random assortment of different meeting-specific prepaid conference and registration fee and meeting-related fee payment deadline information that is collected from and associated with disparate entities (i.e. tradeshow, exhibition, convention, conference, annual meeting, etc) into an organized, packaged, orderly arrangement of structured cash flows for the purposes of a securitization process.

An example of an implementation of the present disclosure is shown by providing a method for “selectively arranging different meetings/events (i.e. convention, meeting, event, tradeshow, conference, symposium, seminar, and workshop) based upon their respective (month-day-year) time-specific deadline date requirements for submission of dollar-specific amounts (i.e. advanced prepaid conference and registrations fees), and using this information as a means of packaging prepaid conference and registration fee cash flows in chronological order accordingly for the purposes of securitization”.

For example, the 2008 National Business Aircraft Association is scheduled to be held on 5-7 October 08 and multiple other meetings and events are scheduled almost every month through 19-24 October 09 when the 59th American Society of Human Genetics is scheduled to be held. In an embodiment, each listed meeting/event has a time-specific date (day-month-year) or “Deadline for Receipt of Advance Registration/Conference Fees” by which each prospective attendee is to submit a specific “Amount of Registration/Conference Fees”, in advance, in order to attend the meeting/event.

The present embodiment teaches how to structure a predictable monthly cash flow stream that can be used as collateral in order to service the debt payment obligations associated with one or more domestic and/or foreign securitization issues.

By assuming that each meeting/event will have 5,000 paid attendees and that 80% of the attendees will have submitted (at least) their prepaid conference and registration fees, in advance, on or before time-specific deadline date, then a financial model can be created and monthly cash flows projections calculated.

Assuming that the total amount of prepaid conference and registration fees for the year is approximately $16,000 and that all of the meeting/event host organizers have collectively agreed to packaging of their respective cash flows use the financing via securitization website portal, then an $80 Million bond could be issued and sold to investors.

In addition, a group event cancellation insurance policy is envisioned as a means of protecting against the risk of a meeting/event being cancelled and the premium amount allocated accordingly on a pro-rata basis among the meeting/event host organizations.

Furthermore, since many conference attendees submit and pay for their conference and registration fees on line using a credit card, and the entire credit card balance is not paid off in full each month, then monthly finance charges typically accrue based upon the unpaid balance. Examples of finance charges include interest charges, annual membership fees, cash advance fees, transaction fees (i.e. overdraft charges, late charges), and other fees charged to the cardholder for use of the card. For those meeting planners and parent/host sponsoring organizations, the accumulated finance charges could be allocated on a pro-rata basis between the entities.

Referring now to FIG. 2, in addition, the present disclosure anticipates creating either a separate non-securitization database for general public use or using an existing social networking-type of database (i.e. http://www.confabb.com) for the purpose of providing a place where anyone can list their upcoming scheduled meeting or event 20. Although this latter database will typically not contain any entity 33 submitted proprietary critical financial or non-financial data and historical information about a current, past, or future planned scheduled meeting/event 20, it will have value as a secondary source of meeting/event 20 information and for the purpose of marketing and contacting potential meeting planners and parent host organization and/or host organizers 25 regarding the merits of the present disclosure.

An Internet-based service 35B offering utilizes securitization database 35A of scheduled meetings and events 20. Internet-based service 35B further represents the part of the securitization 30 process that reviews, analyzes, and models the initial critical financial and non-financial data and historical information about one or more current, previously completed, or future scheduled meeting(s) or event(s) 20 that has been submitted by an event organizer, a meeting sponsor, an in-house or outside meeting planner, a parent host organization and/or host organizer 25. The securitization 30 process is comprised of a team of key decision-makers who interact with all of the required legal, regulatory, financial, accounting, credit agencies, underwriter/placement, investment bankers, securities firms, service administrator, trustee, and the capital markets. This team ultimately makes the final decision to proceed with the issuance, sale, servicing, monitoring, and administration of the bonds associated with one (or more) meeting(s) and/or event(s) 20 involved in the securitization 30 process.

In general, a conference organizer, event host, meeting planner, or organizer who has the primary responsibility for meeting or event 20 comes to the website and registers their particular meeting/event 20. Typically, the individual who signs up for meeting/event 20 will have been given written authority and approval by the governing body and/or Board of Directors of meeting/event 20 in order to act as a legal representative of the organization that is being represented. This person may be an elected official of an Association (i.e. President, Secretary, CFO, etc), an officer of an organization (i.e. CEO, COO), a person who has been designated as the conference or event organizer, a meeting sponsor, the head of a Convention Committee, or a designated meeting planner. After verification of their position, authority, title, and relationship with parent host organization and/or host organizer 25, then that person is granted access to the securitization database 35A.

That person or entity would then enter entity 33 submitted critical information about scheduled meeting/event 20 into securitization 35A database via the website such as the “name of the organization, the date of meeting 20, the starting/ending time of meeting 20, the place or venue of meeting 20, meeting 20 sponsor, the estimated number of attendees, the amount of the fees to be paid per person (i.e. registration, conference, exhibitor, guest, etc), the past three (3) years record of meeting 20 attendance record, whether an event cancellation insurance coverage policy has been bought, tax id number, etc. Additional information about the individual who is submitting the data via the website is also obtained during the registration process, such as their name, title, name of their group or organization, address, phone number, mailing address, email address, and a point of contact for the organization so that authentication, validation, and verification of the submitted meeting 20 data and contact information can be done during any follow-up communication.

Referring now to FIG. 2A, there are additional questions that might be asked on the Data Entry Form, such as:

(a) Does the group have an active trademark to protect its current meeting/event 20 ?

(b) Does the group intend to file a trademark application to protect its current or any future planned meetings/events 20 ?

Referring now to FIG. 2, real-time dynamic financial data is collected and stored as the cash flow payments 10 related to the registration process occurs and prospective attendees 10A submit their remittances (i.e. credit card payments, debit card payments, bank wire, money order, cash payments, etc) either online via the website, the US mail, bank wire, or on-site for a specific scheduled event/meeting 20. Ideally, in an embodiment, the system would be connected with the back-end (i.e. receipt and processing of the financial payments) operational section of the scheduled meeting/event 20 so that it is entirely transparent, user friendly, and does not create an inconvenience or adversely affect the registration process and behavior of the prospective participants and attendees 10A. For example, when an individual registers on line and clicks the “Submit” button to authorize payment of their meeting/event 20 registration fees, then some or all of cash flows 10 will pass directly into the securitization structure 30. The funds are processed, handled, and monitored accordingly by the elements of securitization structure 30 (i.e. special-purpose entity, servicer, issuer, trustee, rating agency, credit enhancement provider, underwriter) in order to ensure the debt servicing of the bonds that are issued and sold to investors. The critical financial and non-financial current and historical data and meeting(s) information would be available for review, analysis, and monitoring by the key decision-makers involved with Internet-based service 35B offering and other authorized users (i.e. structured finance attorney, securitization modelers and analysts, credit specialists, bond rating agency, originators, issuers, event/conference organizers, etc.) who have access to the securitization database 35A.

Links to other companies who are involved in the securitization 30 process such as investment banking, credit rating agencies, law firms, etc could be placed on the Financing via Securitization website 35B to educate potential new clients, educate the general public, and advertising space could be sold to generate revenue to support the website.

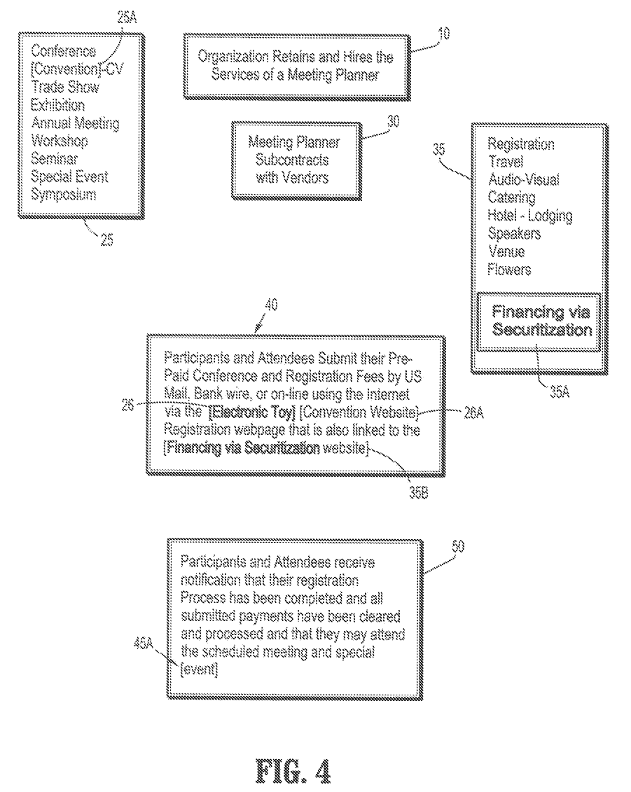

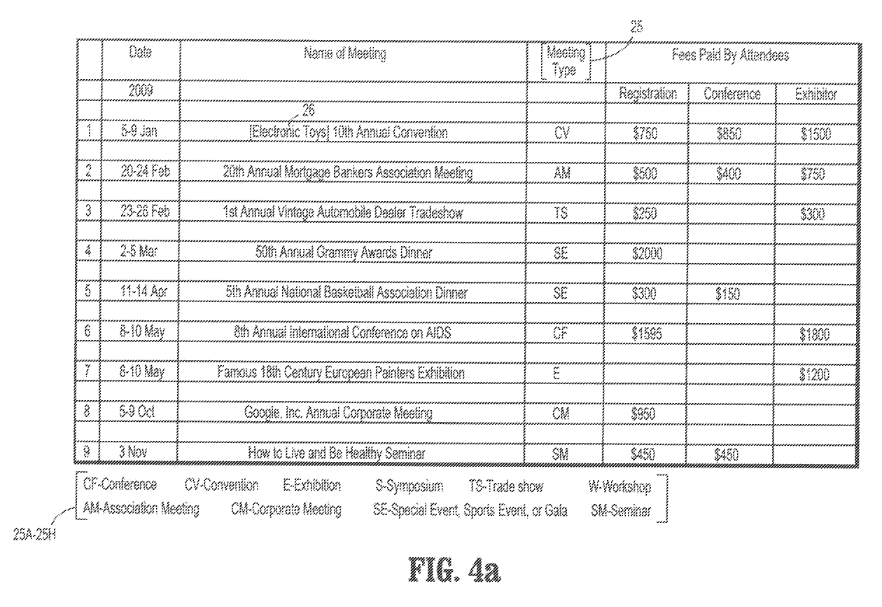

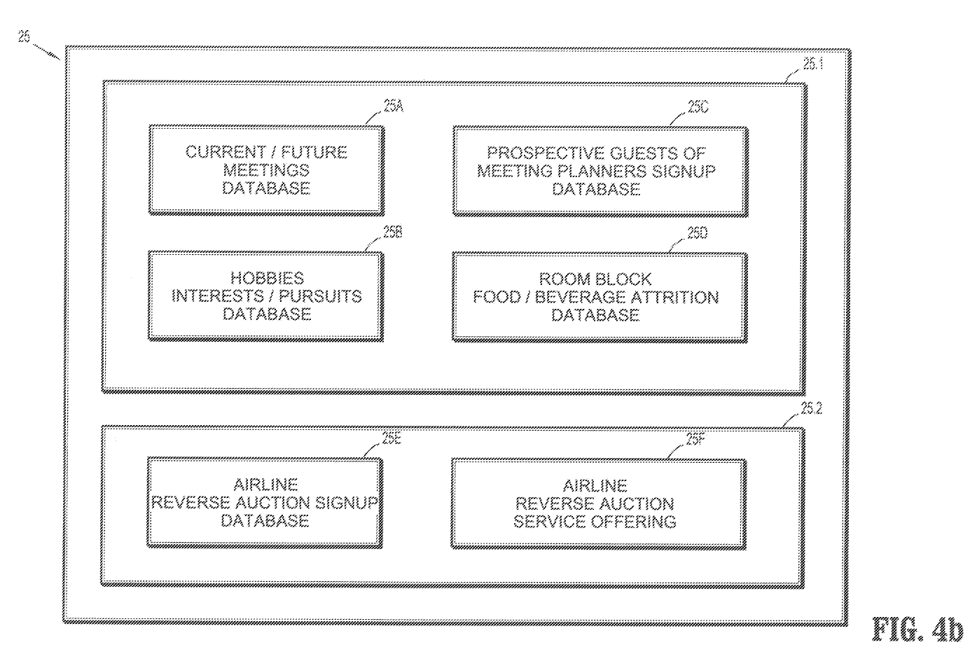

Referring to FIG. 4, another embodiment of a block diagram for the securitization of prepaid fees associated with events is presented. FIG. 4 assumes that an organization has made the decision to retain and hire a certified meeting planner 10 for its upcoming 10th Annual Electronic Toy Convention that will be held on 5-9 Jan. 2009 in New York City, N.Y. The Registration Fee ($750), Conference Fee ($850), and the Exhibition Fee ($1500) for the Attendees and Participants are given (see FIG. 4A, meeting type 25). The conference fee also includes a special event 45A, such as $100 special dinner, with live entertainment for each paid attendee and their guest.

In an embodiment of the present disclosure, the following steps may be performed:
1) Organization retains and hires the services of meeting planner 10 and provides her with an overview of a meeting 25 type of event, an event 25A category and an event description 26, including its theme, goals, expected results, and pertinent historical financial data and attendance records about the previous Annual Electronic Toy Conventions;
2) Meeting planner 10 prepares a detailed plan for event 25 and subcontracts with vendors and suppliers 30 who can perform the specific tasks and provide specific subcontractor needs 35 that meet the logistical requirements;
3) Meeting planner 10 desires to use Financing via Securitization services 35A for event 20 and visits Financing via Securitization 35B website;
4) Meeting planner 10 registers the 10th Annual Electronic Toy Convention and submits the required financial and non-financial data and historical information related to the convention for review and consideration thus establishing a linking between a Convention website 26A and Financing via Securitization website 35B;
5) Participants and attendees complete registration process 40 and submit payment information resulting in all or a portion of prepaid convention and registration fee cash flow payments 50 related to meeting/special event 45A being sent to a specifically created special-purpose vehicle (SPV) account for the purpose of securitization and use as collateral to provide debt service for the issued bonds thus supporting the parent host organization and/or host organizer of the event/meeting 10; and
6) Once an event or meeting has gone through a successful securitization process and the bonds issued and sold to investors, then a section of Financing via Securitization website 35B and/or a link to those parent host organization and/or host organizer websites can be shown listing these organizations and facts about the process (i.e. pre-event, during, and post-event Testimonials).

Referring now to FIG. 4B, another embodiment of a block diagram for the securitization of prepaid fees associated with events is presented. A non-securitization database 25 represents a new system, method, and process for reducing, minimizing, or potentially eliminating room block and food-beverage consumption attrition 25D risks which have always been a major concern for meeting planners and parent/host sponsor organizations. A new service function and role for meeting planners is presented which is designed around a newly introduced concept/program called, “Guest of the Meeting Planner” 25.1 or the “GOMP” program, as an essential component of the meeting planning process in its efforts to reduce these attrition risks. GOMP program 25.1 provides a new way for a meeting planner or parent/host sponsor organization to more effectively manage and exercise control over their meeting-related room block and food-beverage consumption attrition risks.

GOMP service program 25.1 accomplishes this by giving a meeting planner and parent/host sponsor organization the ability to identify, quantify, monitor, and quickly respond to the projected attrition needs of their current (and/or future planned) meetings/events. Using the scheduled current and future meetings database 25A information, tracking of the pre-paid advance registrations submitted by prospective attendees for a given specific meeting can be performed (in real time or via simulation) by a meeting planner and/or the parent host organizer. In order to offset these anticipated (actual or simulated) room block and food-beverage attrition needs, a new user-defined attribute based (i.e. hobbies, interests, pursuits) social-networking type database 25B is created that gives the meeting planner and/or parent/host sponsor organization the ability to efficiently match certain individuals and their personal/professional interests with a current scheduled meeting or a future planned meeting and extend an invitation to those individuals inviting them to be an invited guest of the meeting planner 25C and parent/host sponsor organization and attend the meeting/event.

In addition, non-securitization database 25 further provides an opportunity to expand the scope and the idea of using meeting-related cash flows as collateral for the purposes of securitization. Just as the conference and registration fees that are paid in advance by disparate entities can be used as collateral for the purposes of securitization, the present disclosure envisions using the cash flows that result from the “collective batching of airline tickets” that are partially or fully paid for, in advance, using, for example, a credit card as a form of payment, by disparate entities and using those receivables as collateral for the purposes of securitization. An embodiment by which the securitization of airline tickets can be accomplished is by creating an “airline reverse auction signup database 25E” and providing an airline with the opportunity to participate in a competitive bidding process or “airline reverse auction service offering 25F” as a means of offering its commercial airline passenger transportation services to the general public.

Certain benefits and merits of the present disclosure should be appealing to meeting planner and parent/host organizations who consider using the securitization website portal to list their upcoming scheduled meeting/event 25A. Given the plurality of different scheduled meetings/events occurring throughout the year and each scheduled meeting/event having its own meeting-specific registration process and deadline dates for the submission of any advance prepaid conference and registration fees by a potential attendee, the present disclosure seeks to foreclose others from using the idea of collectively soliciting, batching, processing, categorizing, storing, retrieving, combining, organizing, arranging for the receipt of, and packaging of these advance prepaid conference and registration fees according to a time-specific and date-specific deadline in order to create a schedule of cash flows that can be used for the purpose of meeting debt service payment obligations in conjunction with a securitization process.

Referring now to the GOMP program 25.1, the present disclosure envisions the creation of two relational databases, 25B and 25C, that contains certain personal user-defined 25B attributes (i.e. hobbies, interests, pursuits, profession) and demographic 25C information about individuals, such as, their name, address, email, telephone number (cellular, home, office), home residence, current and future travel plans/itinerary, and other contact information that the individual may voluntarily choose to submit about themselves. This confidential protected personal information will be maintained as a personal profile record, will be updated by the individual, and will be accessible to a meeting planner and/or the parent/host sponsor organization. Some of the personal and contact information may already exist on an existing social-networking or social-dating network website (i.e. Facebook, MySpace, eHarmony) or in the public domain.

The present disclosure contemplates the creation of a software application that utilizes the self-described personal attributes of a person such as their hobbies, areas of interests, professional needs or requirements, pastime activities, leisure pursuits, avocation, intellectual curiosity, or learning desires to create a personal profile record and facilitate the formation of ‘shared interests’ groups based on that information. The creation of a shared interest group can be easily achieved via a “self-selection, self-aggregating, or self-forming” process when an individual initially registers to attend a scheduled meeting/event by having them manually enter this personal information about themselves. Alternatively, the software could ask the individual for permission to access their personal webpage on Facebook, MySpace, or eHarmony in order to obtain some of the user-defined attributes and demographic personal information. Finally, the software could define and create the shared interests groups and its group membership by using certain criteria based upon data that's gleaned via data-mining of freely available public records that can be readily found on the Internet.

For example, “Leonard, a civil engineer, lives in Chicago and has a personal interest in ‘orchid breeding’, ‘antique cars’, and ‘stamp collecting’ and expects to be in Chicago during a particular timeframe (i.e. January-May 2010)”. This personal information is provided by Leonard as he physically enters his personal data via the website portal into a centralized database at the time of initial registration for a scheduled meeting, upon visiting the public use database webpage of the invention, or at a later date whenever he desires to update his personal profile information.

Alternatively, the envisioned software can assign or automatically “aggregate” a person to a particular “shared interest group” based upon demographic and personal information provided by the user and/or information gleaned by monitoring and retrieving data from public records database using data-mining techniques. For example, “Max, a lawyer who lives in New York, is interested in ‘horse-racing’, ‘college football’, and ‘genealogy’ and will be in Miami as a guest professor and teaching at the local law school mini-course during a particular timeframe (i.e. October-November 2010)”.

Assume that at the time of his initial registration in July 2009, Leonard submitted his conference and registration fees via the website portal in order to attend a mandatory civil engineering license recertification event that was set to be held in Miami in January 2010.

Likewise, assume that at the time of his initial registration in July 2009, Max submitted his conference and registration fees via the website portal in order to attend a Continuing Legal Education seminar that was set to be held in Chicago in February 2010.

Further assume that at the time of their registrations, both Leonard and Max had signed up to be the guest of a meeting planner for any meeting or event that was related to one of their personal interests/hobbies/pursuits and that unbeknownst to each other, their respective wives (Donna and Beth) both have a common interest in “playing bridge”.

During the registration process, it is anticipated that other immediate or related family members (i.e. children, spouse, significant other, etc.) will desire to have their own personal interests/hobbies/pursuits listed and linked to the respective profile records of other family members in the database (or set up their own personal profiles, depending on their age).

One month later, Leonard receives an email invitation from a meeting planner and host/sponsor parent organization to be one of the guests at a stamp collecting conference that's being held in Chicago in August 2009. Leonard confirms his acceptance of the invitation from the “stamp collecting event” meeting planner via reply email. Since Leonard lives in Chicago, then the meeting planner made the decision to offer him an opportunity to participate as a guest at either a food and beverage event, attend a “Introduction to Stamp Collecting (Basic, Intermediate, Advanced) Course”, or attend both events in order to reduce the potential attrition risks of being unable to fulfill any contractual food and beverage consumption requirements.

Max has to go the Chicago for an unexpected trial in August 2009 and he decides to bring his family and his wife (Beth) and have a business/family vacation. While en-route to Chicago, Beth receives an email invitation to be a guest at a “playing bridge workshop” that is being held in Chicago during the same week of the trial at the same hotel where the “stamp collecting conference” is taking place. With this fortuitous new information, Beth eagerly confirms/accepts the invitation and Max changes his intended hotel reservation and books his family at the hotel where the “playing bridge workshop” is being held. Because it just so happens that Max and his entire family will be staying at this specific hotel in Chicago during this time and Beth is an invited guest of the “playing bridge workshop” meeting planner, then the meeting planner will be able to claim them (the entire family) as “guests” and thus offset the potential financial penalties associated with any attrition risk related to hotel room block pickup.

While staying at the hotel, Max and Beth happen to meet Leonard who then learns about the “playing bridge workshop” from Beth. Leonard tells his wife about this workshop, and Donna expresses an interest in attending it and sends a request to the meeting planner inquiring about any additional guests invitations that might be offered during the next 48 hours. Sure enough, the “playing bridge workshop” has an unexpected cancellation and she sends an invite to Donna who quickly confirms/accepts the invitation to attend as a guest.

The software would be able to further filter and sort members of a group based upon several different criteria such as (i.e. “future planned dates of travel”, “State of residence”, “occupation”, “profession”, etc.) using their user-defined attributes and demographic personal information that the person inputs via the website GUI into centralized Guest of Meeting Planner signup database 25C. In particular, the software would be designed to identify those individuals who express a personal interest, desire, and willingness to accept an invitation to be the guest of a meeting planner or parent/host sponsor organization at a current or future planned scheduled meeting.

By using either “self-selection” and/or the “software-defined automatic aggregation”, one or more groups can be created, a list of names and contact information generated, and the total number of members in a shared interest group can be made available to a meeting planner, event sponsor, or host organizer for the purpose of having these individuals as potential “guests” at a scheduled event/meeting that is being planned by the meeting planner.

For example, if a meeting planner knows that 10% of their projected attendance will not show or cancel (based upon past historical meeting attendance data), then the meeting planner and/or parent host sponsor organization can offset this risk by providing an equal number of guest passes and making these passes available to this selected list of individual guests who expressed a personal or professional interest (i.e. hobby, avocation, etc) in attending the scheduled event and whose travel plans coincide with the place, time, and dates when the meeting was being held.

By querying a database containing demographic and personal information on individuals whose interests, professional needs or requirements, hobbies, vocation, or learning desires match certain criteria related to a current or upcoming scheduled meeting, a meeting planner, event sponsor, or host organizer could proactively query this targeted population and make them aware of the scheduled meeting/event and invite them to be their guests at the meeting/event. The parent/host organization could offer the guests free or discounted tickets to attend either/or an exhibition, lecture, or food and beverage event during that week, or setup a rain check for a future date.

By preparing and having a list, in advance, of potential individuals whose personal residence and/or expressed travel plans and dates happen to coincide with, overlaps with, or will bring them within the same city or in close proximity (i.e. 20 miles) to a venue where a major scheduled meeting will be taking place and by extending an invitation to the members of this ‘shared interest’ group, a meeting planner, event sponsor, or host organizer can increase the likelihood of one or more of them accepting the invitation and being ready, willing, and available to participate in a food and beverage event at either no cost or a nominal fee. Those group members who accept the invitation to attend could RSVP and indicate their intention to attend part or the entire scheduled meeting/event and the time of their desired expected attendance.

For those individual members of a shared interest group who may be traveling through a city during a certain time and place where a scheduled meeting is being held, a meeting planner, event sponsor, or host organizer could extend an invitation to them and invite them to stay at the same hotel where the meeting is being held and/or participate in the meeting event as an invited guests. Upon receipt of any acceptances and confirmations that the invited individual(s) will attend as a guest(s), then the meeting planner and host/parent sponsor organization could then expect to claim all those individuals who actually come and stay at the hotel and/or participate in the food and beverage events as having contributed to either the required daily “hotel room block pickup”, and/or the required “food and beverage consumption” requirements and thus the guests will serve a valuable role in helping to offset, reduce, minimize, or potentially eliminate any “hotel booking attrition” and/or “food and beverage attrition” risks that the meeting planner faces.

In certain highly popular destination cities (i.e. Orlando, Chicago, Las Vegas, etc.) where meetings are often held, there may be enough members who belong to different shared interest groups that locally reside in that city such that, a meeting planner and/or parent host sponsor organization can extend enough invitations to the local shared interest group members, especially for the purpose of offsetting the ‘food and beverage’ attrition consumption risk since this latter group would most likely not be interested in staying at the hotel in the city (where they already live), but would be willing to accept an invitation to attend a food and beverage function since they would ordinarily be probably going out for dinner sometime anyway during that week.

The database of individuals and the shared interests groups effectively functions as a supplier of interested guests of a meeting planner for a scheduled meeting/event. Likewise, it also serves as a supplier of potential new prospective members for a parent/host organization since these same individuals could eventually become paid members of that organization as a result of initially having been a guest at one of their scheduled events/meetings.

The Guest of Meeting Planner program 25.1 would thus be able to serve an important role and function in the overall meeting planning process, provide a valuable service to the parent/sponsor host organization, assist in the recruitment of new potential members and the membership growth of an organization or association, and help to increase the overall goodwill and brand name of an organization or meeting/event on a local, national, and international level.

It is contemplated that the present disclosure can create value for individuals who attend a meeting or event prior to, during, and after a scheduled meeting/event has taken place. For example, the earlier an individual chooses to submit their registration/conference fee via the securitization website portal, the more opportunity, access to, and times that they will have to receive and enjoy the potential benefits of being a member of a shared interest group and the GOMP program 25.1.

For a parent/host organization, the GOMP program 25.1 provides an opportunity for it to create “new content” and enhance their meeting agenda (i.e. “Introduction to the Meetings Industry”) as a way of attracting college students and young adults to consider becoming a future professional meeting planner as a career choice, encourage new prospective members to get involved with local chapters, etc. In addition, a parent/host organization could set a goal to convert 50% of the guest attendees into paid members within 1 year of the event and offer them a discounted membership rate during the 1st year of joining.

It is contemplated that the present disclosure can benefit individuals who submit their conference and registration fees via the financing via securitization website to reduce or eliminate the additional processing fees (i.e. $50, $75) that many conventions and meetings charge in the event that an individual cancels their registration or is a “no-show” for the scheduled meeting/event.

Referring now to social-networking type database 25B, the database may be used in order to motivate, collect, categorize, store, and retrieve certain types of user-input related demographic and personal information that can be later matched with the interests and hobbies of other individuals (i.e. famous celebrities who share a similar interest) for the purpose of forming shared interest groups. User-defined attribute-based database 25B provides a means for individuals to voluntarily provide certain personal information about themselves that can be stored on an individual basis or in an aggregate fashion, depending on the degree of privacy that the individual desires to maintain.

It is contemplated that the present disclosure may foreclose others from using the idea of soliciting, collecting, categorizing, storing, retrieving, and matching information submitted by individuals regarding their personal and professional interests, hobbies, pursuits, and avocations in order to create a listing of potential “guests” of a meeting planner or “guests of a parent sponsor/host organization” of a scheduled meeting/event as a means of offsetting or reducing the risks of “hotel attrition” and/or food and beverage” attrition due to no shows, late cancellations, booking outside of the room block.

Referring now to Room Block/Food/Beverage Attrition Database 25D, the present disclosure envisions a meeting planner and/or parent host sponsor organization listing their daily “hotel attrition” shortfall needs and their expected “food and beverage attrition” shortfall needs on the website portal so that potential guests can see what is available that could match their interests, availability to attend, travel itinerary schedule, etc. This daily “attrition needs shortfall” information could be stored in “Room Block/Food/Beverage Attrition Database 25D” that is updated and maintained on a real-time basis by meeting planners and/or parent host sponsor organizations, is readily available for viewing by the public, and allows information contained within it to be communicated (via email, text message, fax, etc) to members of different shared interest groups who may reside in multiple different locations where different meetings/events may be taking place.

The following is an example of a hypothetical scheduled future planned meeting and the anticipated (simulation) hotel room and food and beverage attrition shortfall needs for each day of the event. The information was generated four (4) months prior to the meeting date using historical data from the past five years that was provided by the host organization.

| | |
|---|---|
| City and State of Meeting | New York City NY |
| Name of Meeting | Electronic Toy 10^{th} Annual Convention |
| Expected Number of Attendees | 1500 |
| Date | 3-6 SEP 2009 |
| Expected Hotel Guest Needs | 50 |
| Expected F&B Guest Needs | 80 |
| Days of Expected Shortfall and | Thursday - 60 (Dinner) |
| # Needed | |
| | Friday - 70 (Black Tie Reception) |
| | Saturday - 100 (Guest Speaker Event) |
| | Sunday - 50 (Luncheon) |

Using the simulation results, a meeting planner and/or parent host sponsor organization could conduct a monthly query of the “hobbies/interests/pursuits database 25B” and initiate contact with existing members who have similar hobbies and interests that belong to the “Electronic Consumer Toys” shared interest group and who live within a 100 mile radius of the scheduled meeting site to determine their level of interest and availability in attending the meeting as an invited guest. Since these individuals would most likely not be willing to travel back and forth each day for the 4-day meeting, then there exists an increased likelihood that anyone who accepted the invitation would be willing to stay at the hotel and participate in any food/beverage functions. Depending upon the number of confirmed responses to any invitations sent out, the database query could be expanded to include other shared interest groups (i.e. “Electronic Toy Design”, “Electronic Toy Collecting”, etc.) as the meeting date approaches.

As the four (4) day meeting progresses, attendees and participants will typically begin checking out of a hotel in increasing numbers up until the very last day of the meeting. Thus, on any given day, a meeting planner may not be able to accurately predict how many rooms in their room block that they will be held accountable for due to various reasons beyond their control (i.e. an attendee gets sick and leaves early, an attendee checks out and goes to a cheaper hotel, an attendee does not show, etc). This creates an unpredictable situation for the meeting planning process because meeting planners have very little control over and means of matching and fulfilling their daily “hotel room block and food/beverage requirement” needs.

The above simulation results and the confirmed accepted invitations of querying the prospective guests of meeting planners database 25C provides a new meeting planning process tool that could assist them in their negotiations with hotels and meeting sites. Without a new potential source of readily available potential interested individuals who could and would be willing to attend/participate in a scheduled meeting/event as a guest or an attendee, a meeting planner has few and limited options available for handling the uncertainties related to hotel room block attrition and food and beverage attrition risks.

Referring now to FIG. 2A, the form could be modified to include an additional question for a meeting planner or parent/host sponsor organizer to answer, such as:
“How many guests will be needed each day to offset your anticipated room block shortfall?”
“What percentage of your requested total hotel room block do you anticipate will be offset by guests?”
“How many guests will be needed each day to offset your anticipated food and beverage consumption requirements shortfall?”
“What percentage of your anticipated food and beverage consumption do you anticipate will be offset by guests?”
“What actions or plans has your group successfully implemented to reduce, mitigate, or eliminate your hotel room block and food and beverage consumption requirements attrition risks in the past?”

Referring now to FIG. 4B, the present disclosure contemplates having the means of providing this information to a meeting planner, event sponsor, or host organizer in advance and thus it advantageously gives meeting planners, event sponsors, and host organizer a way to minimize their potential financial risks due to attrition, no-shows, or cancellations.

The meeting planner, event sponsor, or host organizer could implement this by determining in advance, how many guest passes to prepare each day based on the number of confirmed RSVP responses that are received within a certain time frame using the database query. By serving as a means of attracting and bringing together individuals who have shared related interests, the “public database” of the securitization website portal, is able to supply interested “guests” for meeting planners and parent/host organizations and thus potentially reduce or minimize the financial and non-financial risks due to hotel attrition and food/beverage attrition that has been a long-standing concern for the entire meetings industry.

Referring now to an Airline Reverse Auction Signup Database 25E, airlines need a way to handle the plethora of individuals and small-mid size companies that have limited travel spend (<$2 Million per year).

In an embodiment of the present disclosure, a system, method, and process for using the cash flows associated with the payment of airline tickets (i.e. credit card receivables) as collateral for the purposes of securitization is presented. In another embodiment, reverse auction travel booking engine is provided wherein individuals can register and self-aggregate themselves into groups for the purpose of being able to submit their credit card to purchase airline tickets and potentially obtain a lower average price per ticket as a result of a competitive bidding process among the airlines.

In contrast to the traditional frequent flyer airline marketing program offered by most scheduled passenger commercial airlines whose main objective is to encourage air travelers to earn miles that can be redeemed by becoming and remaining loyal to a particular airline, reverse airline auction 25.2 is focused on providing a way to potentially reduce the overall airline costs and expenses that individual travelers and small-mid size companies incur as a result of air travel. Although an individual may earn miles as a result of air travel on a particular airline, there is no guarantee that earning miles will occur.

Reverse airline auction 25.2 is proposed as a way of giving the commercial scheduled airline industry an opportunity to potentially operate more efficiently and thus lower their overall operational costs and become more profitable while serving the travel needs of the general public and the plethora of individuals and small-mid size companies that have limited travel spend.

As is similar with the prospective guests of meeting planners signup database 25C to create and self-aggregate themselves into shared interest groups, the reverse auction signup database 25E provides an individual with an opportunity to register themselves and become a member of a “self-forming city-pair” group in order to travel via commercial passenger airline from a certain point of origination (City A) to a certain point of destination (City B) on a certain departure date and at a certain departure time, at a discounted group rate, where City A and City B constitute a “certain city-pair”.

These “self-forming city-pair groups” are open for membership to anyone who desires to participate and create a personal profile of themselves by submitting their personal contact information into the public use database 25 so that communication can be established between the website and the individual who desires to use this method of obtaining air travel services.

Just as the collective batch payment of registration and conference fees from disparate entities can be used as a proxy for a national convention that consists of 1,000 paid attendees, a collective group of disparate individuals who have similar airline travel needs can self-aggregate themselves based upon user-defined attribute based factors for the purpose of traveling to/from points of origination/destination sites and receiving and enjoying potential airline travel benefits at a discount group rate.

Once a city-pair group has been formed and reaches a certain number of members for a given time and date, then the group is presented to airlines that have expressed an interest and willingness to enter into a competitive bidding process for the right to become the scheduled airline carrier for this group of travelers. Since each individual commercial airline will typically have different operational constraints, budgeting requirements, passenger yield management goals, forecasting needs, then it is envisioned that each participating airline will submit competitive bids that best matches their own individual business objectives, financial needs, and marketing strategy. Thus, a person who needs to travel via air would be ‘sought after’ by the airline itself based upon the wants and needs of the airline and its business model.

It is envisioned that these “self-forming city-pair groups” would be spontaneously created on a daily basis for a certain date and time of departure throughout all major city-pairs around the world and once the airline service has been provided, then the group for that “certain departure date/time/city pair” would dissolve. The process would repeat itself for different departure dates/times/city-pairs throughout the day in a continual fashion.

For example, assume that 250 disparate individuals have all registered themselves in the reverse airline auction signup database 25E and a group has been formed that represents “travelers who wish to fly from Boston to Chicago on Friday 21 Aug. 2009 and they desire a departure time of 10:00 am (EST)”. This self-forming group would be referred to as the “21 Aug. 2009/1000/Boston-Chicago” city-pair group.

Each individual in this city-pair group would submit a credit card payment in a nominal amount (i.e. $100) in order to register themselves and reserve their name as a member of the “21 AUG 09/1000/Boston-Chicago” city-pair group in the reverse airline auction signup database 25E. The actual processing of their credit card transaction may not take place until the day that the group actually departs on their scheduled flight.

The airline that submits the lowest competitive winning bid would notify the group members, in advance, with the flight itinerary (i.e. flight number, departure gate, carry-on travel restrictions, etc). For those travelers who desire to fly first class, the registration fee to reserve their name in the reverse airline auction signup database 25E may be slightly higher, such as $250, whereas, for a traveler who desires to fly coach, the registration fee to reserve their name in the database may be much lower (i.e. $100).

Multiple factors can affect the bid amount that an airline may submit, including, but not limited to fuel costs, aircraft positioning, the availability of aircraft, the aircraft size and class, age and maintenance of the aircraft, flight crew availability, including the fact that airline prices may vary from a low of $288 to $1988 per person for the same flight and travel itinerary from one or more airlines.

Additional self-aggregating city-pair groups can be easily formed based upon different travel itineraries accordingly:

| | Name of City-Pair |
|---|---|
| Membership Criteria for City-Pair Group | Group |
| Travelers who desire to fly from Boston to Chicago | 21 Aug. 2009/1200/ |
| on Friday 21 Aug. 2009 at a different departure | Boston-Chicago |
| time such as, 12:00 pm (EST)″ | |
| Travelers who desire to fly from Boston to Chicago | 21 Aug. 2009/1400/ |
| on Friday 21 Aug. 2009 at a different departure | Boston-Chicago |
| time such as, 2:00 pm (EST)″ | |
| Travelers who desire to fly from Boston to Chicago | 21 Aug. 2009/1800/ |
| on Friday 21 Aug. 2009 at a different departure | Boston-Chicago |
| time such as, 6:00 pm (EST)″ | |
| Etc. | |

The total price that each traveler will pay is dependent on the lowest winning bid that is submitted by an airline. For example if airline A submitted a bid of $100K and it was the lowest winning bid for a group of 250 travelers, then the average ticket price that would be paid is $400 per person per ticket. Each traveler who registered with the group would then be charged the outstanding balance of $300 to their credit card to pay the balance in full the day of the actual travel. The anticipated annual cost savings that each traveler can potentially receive by collectively participating in a self-forming group could have a direct positive impact on how small-mid size companies manage their travel budgets.

Referring now to Airline Reverse Auction Service 25F, auction service 25F may be utilized by using at least one or more digital computers, computer servers, computer databases, and creating a network to run one or more application software programs that results in the transformation of a random assortment of different airline flight itineraries for the same city-pair and departure time and date that is generated by multiple airlines and each itinerary having various ticket prices into a simple single line output consisting of a single airline that has won the right to provide the requested service by being selected as the winner among several airlines who engaged in a competitive bidding process.

The plurality of disparate entities/individuals who self-organized themselves into certain city-pair groups in order to participate as members of a airline reverse auction process are thus now provided with an easy convenient method and means of obtaining the desired commercial airline services that they need at a reasonable and potentially cheaper price than they otherwise may not have been able to obtain on their own individual efforts.

In an embodiment, a method of deploying and implementing the application software program could be, for example, using the SaaS model or “Software as a Service” model whereby customers are given access via the Internet to at least one or more software applications that is hosted on at least one or more network computers or emerging technologies (i.e. cell phone, PDA, wireless device, etc). One software application could be hosted on a network computer that is dedicated only to tradeshows and supported by meeting planners and parent/host sponsor organization responsible only for tradeshows. Alternatively, a software application could be hosted on one or more network computers that are dedicated to processing multiple different types of meetings/events that are scheduled for a certain month or quarter for a given year.

In an embodiment of the present disclosure, the following steps demonstrate how the airline reverse auction service 25F offering works:
a) prospective airline customer submit the certain departure date/time/city-pair itemized information to a central database via a secure website portal that runs a Software-As-A-Service (SaaS) application;
b) the Software-As-A-Service implemented on the website then aggregates the received consumer data into groups of say 25, 50, 100, 300, 525 individuals by name;
c) individuals may have a choice as to what ‘group size’ they want to be placed in (i.e. small, medium, and large);
d) the SaaS then creates a listing of the number of groups and list of aggregated names (in encrypted format) in each group;
e) this list is then made publicly available on the website in order for the airlines to submit a competitive bid for these customers;
f) the SaaS determines which airline submits the lowest bid among those airlines that desire to participate in the bidding process;
g) a deadline is established that requires the airline to confirm its acceptance of the “awarded contract” if it is selected the winner of the bidding process; and
h) the awarded contract requires performance by the airline meaning for example, that it has to make available a plane specifically dedicated for this group size** of customers.

(For example, if the airline bid is for 295 customers, then the airline will need to have an Airbus A330-300 available—since only this size aircraft can seat 295 customers).

The website would reserve the right to substitute ‘standby’ passengers on the list that is submitted to the airline. For example, one airline may allow up to 40% of the listed names in a group to be substituted according to their “Group Sales” webpage.

The airline reverse auction aspect of the non-securitization database 25 available for use by the general public provides a logical extension of using the cash-flows associated with a scheduled meeting as collateral for the purposes of securitization. Further, it can be applicable to the disparate entities (i.e. individuals, small, mid-size businesses) who have limited travel spend and budget constraints.

The self-aggregating certain departure date/time/city pair groups is analogous to having a plurality of scheduled meetings/events. Instead of 1,000 attendees submitting their credit card payments in advance for their conference and registration fees related to a single scheduled meeting/event, there are 25, 50, 100, 300, 525 individuals who collectively submit their credit card payment information in advance to the reverse auction signup database 25E related to the purchase of airline ticket/travel related/GOMP services associated with a single certain departure date/time/city pair. By extending this analogy to multiple airports with multiple certain departure date/time/city pair, additional network benefits are envisioned.

The idea of collectively soliciting, batching, processing, categorizing, storing, retrieving, combining, organizing, arranging for the receipt of, and packaging of these advance partially or fully paid airline ticket travel-related cash flow payments according to a “certain departure date/time/city pair” for the purpose of creating a schedule of cash flows that can be used as collateral to meet debt service payment obligations in conjunction with a securitization process is thought to be a logical extension of the present disclosure”.

Referring now to FIG. 5, in an embodiment of the present disclosure, the vast majority of the conference and registration fee payments made related to a scheduled meeting or event is done using a major credit card or debit card as the predominate form and means of payment.

The present disclosure has identified a unique asset class category, specifically “prepaid registration and conference fee payments made in association with a scheduled event or meeting that is useful for the purpose of securitization. As subset of the asset class credit card receivables category, this predictable, reliable, stream of cash flows, existing in the form of “paid in advance” or prepaid registration fees and conference fee payments, as well as other meeting-related income and revenue can be used as collateral in a credit card receivables securitization structure.

Likewise, for the purposes of the present disclosure, the use of a Federal or State trademark that is associated with an annual meeting or event can also be used as a form of additional collateral in a credit card securitization structure related to the meetings and events industry. Some organizations hold an annual meeting in order to raise funds to operate, yet, they have not taken steps to protect the intellectual property rights associated with their annual meeting.

The hotel lodging industry is a $100 Billion business and the “food and beverage” component of the lodging industry is a $425 billion business. When an event planner makes a deposit for an event/meeting, the hotel typically will record those received funds as a “Current Liability” if the event will occur within the next twelve months. Otherwise, the received funds would be recorded as a “Long-Term Liability” to reflect the fact that the event/meeting will not occur until after at least one year from the date the deposit is received. Therefore, on the hotel's balance sheet, these received pre-paid advance hotel deposits represent future liabilities or debt obligations. Thus, it is possible to use these received hotel deposits, that exist, in the form of a prepaid meeting-related (i.e. credit card, debit card, bank wire, money order, or cash) payment as collateral for the purposes of securitization.

The present disclosure envisions the creation of a joint “seller” agreement between the payment recipient (hotel venue owner) and the parent host organization and/or host organizer of a meeting that provides mutual benefits for each party. For example, a hotel cannot recover lost profits from “no shows” that might have used other services in the hotel during their stay. Likewise, a parent host organization/host organizer of a meeting/event may incur economic damages due to an attrition clause that exists in its contract with the same hotel. Therefore, there exists an opportunity to offset the potential losses that both parties face by using a joint “seller” agreement and a securitization structure. More specifically, a hotel could securitize its prepaid hotel deposits and a meeting planner could securitize the pre-paid conference and registrations fees for a meeting that it planned to be held at the same hotel. As a result of the securitization process both parties will realize a certain amount of cost savings. The two parties could then negotiate a joint “seller” agreement and use the combined cost savings from the securitization structure to offset the yet-to-be-known lost profits and economic ‘attrition-related’ damages that each party potentially has, as a result of their respective risks.

In an embodiment of the present disclosure, a master trust structure such as a master note trust, or a master owner trust (MOT) is used for the securitization of credit card receivables. Although, it is possible to use a simple stand alone trust for credit card securitization, this approach is somewhat limited in that it would only allow a single pool of card receivables to be sold to the stand alone trust and used as collateral for a single security. In contrast, by using a master trust structure, there are several advantages: (a) the ability to create multiple securities from the same pool of receivables; (b) greater flexibility of adding additional receivables over time and issuing more securities; (c) lower costs; (d) shortening of the cash cycle; and (d) improved liquidity.

There are four main documents associated with the securitization transaction, labeled:

1) A Pooling and Servicing Agreement 10;

2) A Series Supplement 20;

3) A Master Indenture Agreement 30; and

4) An Indenture Supplemental Agreement 40.

Master Indenture Agreement 30 and any Indenture Supplemental Agreement 40 creates a Master Note Trust 90 and establishes the relationship of the parties who are involved in the securitization transaction. These two documents also govern the issuance of the receivable-backed notes and obligations of the trust. Although a Master 70 Trust is independent, separate, and a wholly owned entity, it is operated for the mutual benefit of the parent host organization and/or host organizer (i.e. meetings industry seller 50) and the investors. Pooling and Servicing Agreement 10 and Series Supplement 20 outline the obligations and duties of the respective parties and provides for the transfer and conveyance of credit card receivables 60 to the trust and as well as for servicing and administering of the receivables. A collateral certificate 80 is issued by Master Trust 90 and is the issuer's primary source of funds for the payment of principal of and interest on the issued securities (i.e. Meeting series notes 100) that are sold to Note holder investors 110.

In this securitization example, it is understood that there is no limitation on the right of the issuer with regards to issuing new series, classes, or tranches of notes. It is contemplated that the indenture permits favorable terms for benefit plans, such that every class that is offered will provide notes that can be purchased which are ERISA-eligible.

Referring to FIG. 5A, another embodiment of a block diagram for the securitization of prepaid fees associated with events is presented. FIG. 5A provides a master note trust and the flow of credit card receivables from meetings industry seller and servicer 10 into a Master Trust 20. Master Trust 20 determines what the seller interest 20A and the investor interest 20B will receive as well as their respective share of the cash flows and pro-rata share of charge-offs. Accordingly, seller interest 20A denotes the residual ownership interest that the credit card issuer must maintain and investor interest 20B denotes the principal amount that is owed to investors in the securitization. These pro-rata cash flow and finance charge-off allocations are made, for example, according to whether the issued securities have common attributes (i.e. fixed-rate versus a floating rate coupon series) and whether all of the series are grouped together (i.e. series A 30) or differently (i.e. series B 40) based upon their respective coupon attribute.

Referring to FIG. 5B, yet another embodiment for the securitization of prepaid fees associated with events is presented. FIG. 5B provides a master owner trust (MOT) “de-linked” securitization structure consisting of an existing credit card master trust 10 and a new master owner trust 30 and three series of securities. One series 40, is further comprised of a tranche 48 that consists of three linked subordinate classes (i.e. Class A 45, Class B 46, and Class C 47) that are used for the purpose of share enhancement 49. Share enhancement 49 provides a way to protect investors from losses related to the underlying collateral and also it allows the use of other items as a way to possibly achieve a higher credit rating for the issued securities. Share enhancement 49 can be obtained using subordinated securities, cash reserves, over-collateralization, surety bonds, etc. In an embodiment of the present disclosure, there are several items that can be used for share enhancement 49: (a) the Federal trademark of a meeting; (b) meeting-related income (i.e. prepaid advertising space revenue) and other revenue streams (i.e. dinner tickets, tour, publications); (c) “joint” seller agreement that stipulates sharing of the cost savings (i.e. prepaid hotel deposits and attrition clause damages) resultant from the securitization; and (d) other subordinated securities.

A collateral certificate series 2009-D 28 that represents a portion of the (shared) undivided investor interest in the assets of the Master Trust for the issued series is also provided. There are three other series denoted as Series 2009-A 25, Series 2009-B 26 and Series 2009-C 27 in the securitization structure. Each of these series is comprised of separate classes and meeting type categories (labeled 25A, 25B, 25C; 26A, 26B, 26C; and 27A, 27B, 27C and 27D) and each series may have varying dates of maturity, risk, and rewards.

These meeting type categories and their category abbreviations are:

| Label | Meeting Type Category | Category Abbreviation |
|---|---|---|
| 25A | Conference | CF |
| 25B | Convention | CV |
| 25C | Exhibition | E |
| 26A | Seminar | S |
| 26B | Trade Show | TS |
| 26C | Workshop | W |
| 27A | Annual Meeting (i.e. Association) | AM |
| 27B | Corporate Meeting | CM |
| 27C | Special Event | SE |
| 27D | Seminar | SM |

Referring now to FIG. 3, another embodiment of a block diagram for the securitization of prepaid fees associated with events is presented. On the left side of FIG. 3, the drawing depicts the cash flows and pooling of assets (i.e. pre-paid registration and conference fees) from one or more meeting type(s) 25 to an originator 10 wherein it is understood that the cash flows are payments that have been submitted by an attendee, participant, exhibitor, guest, or sponsor to at least one or more event categories 25A thru 25G for the purpose of attending a scheduled meeting or event that is sponsored by a parent host organization or host organizer. By pooling and aggregating these assets from different types of meetings and events before tranching occurs, originator 10 provides an opportunity to diversify the idiosyncratic risk that is unique to each event organizer, venue, type of meeting, etc. Further on the right side, the separation of the cash flows from the assets into a debt 30 and the existence of a credit rating 40 that is associated with this debt 30 is shown. It further shows different types of debt 30A thru 30D tranches (along with an equity 30E) and their associated level of risk as indicated by the credit ratings 40A thru 40F. For example, senior debt tranche 30A has a credit rating of AAA 40A because it is considered the safest and least risky debt. Whereas, mezzanine 30B and junior 30C debt tranches are shown has having greater levels of risk and a credit rating of BBB 40C and CCC 40E.

Referring now to FIG. 3A, another embodiment of a block diagram for the securitization of prepaid fees associated with events is presented. Another objective of the present disclosure is to reduce the overall costs and expenses that an individual, a small company, or a new start-up organization may incur each year as a result of sending one or two individuals to a scheduled meeting or event each month. Since an individual who is self-employed or a small organization may not be able to receive any type of monetary discount for these twelve to twenty four people collectively at a “group discount rate” because of the scheduled meetings being spread out over an entire year, then typically, the costs to attend a meeting or an event may be much higher on an individual basis or per employee basis.

In contrast, larger corporate entities are able to negotiate attractive group discount rates from different suppliers of products and services (i.e. hotel, bus, airline, conference and registration fees, etc) for their employees because the suppliers hope to establish a long-term business relationship that generates enough volume of customers to offset the lower amount that they receive compared to what they would typically charge a single customer—with the expectation that the resultant revenue will make them a profit. The supplier may offer a group discount rate that is ten to thirty percent (10-30%) below the normal price that they would ordinarily charge a single individual who attends the same meeting or receives the same product or service. The savings that an organization obtains as a result of a group rate discount can be significant and range in the hundreds to thousands of dollars per year.

An airline will often consider offering a group discount if there will be at least nine (9) people who will all be traveling as a group together on the same date, the same airline, the same flight, and who will all be returning together as a group. However, at times, even a large corporate entity may not be able to take advantage of receiving a group rate discount even though it has enough people who would all be traveling on the same date, the same airline, and the same flight.

For example, assume that there are two-thousand (2000) different companies representing one-hundred (100) disparate industries from around the world that each expects to have ten (10) different individuals from various parts of their organization attend one or more different scheduled meetings and events which all start on the same date, but occurs in different places, and last one to five (1 to 5) days during the month of January in the year 2010. Each of these companies may or may not: (a) operate in the same industry (b) compete in the same or a different geographic area (c) serve the same or different set of customers; and/or (d) offer the same or offer different products and services. In an embodiment of the present disclosure, each of these organizations will be paying the same amount of registration fees and conference fees ($500 US dollars) for their respective employees to attend their respective meeting. An example of a typical meeting and event schedule is shown for a single mid-market size company called Sue's Plumbing Business 10C for the month of January 2010:

| | Name of Meeting That the Person Will |
|---|---|
| Title | attend in January 2010 |
| CEO, Sue Plumber | Business Roundtable Annual Meeting - |
| | Chicago IL |
| President | Annual Tradeshow - Boston MA |
| CFO | Corporate Finance Officers Association |
| | Seminar- NYC NY |
| COO | International Workshop/Conference - |
| | Rome Italy |
| General Counsel | American Bar Association Annual Meeting - |
| | Miami FL |
| Marketing Executive | 5^{th} Annual Marketing Convention - Memphis TN |
| VP- Sales | 6^{th} Annual Sales Exhibition - Houston TX |
| VP Director, Research | Regional Symposium - Atlanta GA |
| Head, IT Department | Future Trends in IT Convention - Seattle WA |
| Meeting Planner | Convention Industry Council Seminar - |
| | Honolulu HI |

If all two-thousand (2000) companies had a similar meeting and event schedule, then this would be the equivalent of having a “convention” consisting of twenty-thousand (20,000) people who each pays five-hundred dollars ($500) in the form of a registration and conference fee and thus generates a cash flow payment in the collective amount of $10 million for the month of January 2010.

In an embodiment of the present disclosure, a means of collectively batching the conference and registration fees paid by prospective attendees from disparate entities in association with a scheduled meeting or event is provided. Wherein, those entities may include an individual who is not affiliated with a large organization, a small or mid-size firm, a sole proprietor, or a self-employed small business-person. By providing a means for allowing different individuals and small companies to “pool” their paid registration and conference fees associated with a scheduled meeting and event together and having those received payments submitted by the financing via securitization website (possibly ten days later) to the appropriate meeting website, then collective batching of these payments can be used for the purpose of collateral related to the securitization of a bond.

FIG. 3A shows multiple disparate companies and individuals 10 (denoted as 10A thru 10G) from various different industries and business sectors that typically look for a scheduled meeting or event 20 that satisfies their particular business, social, personal, or professional needs. Once a specific meeting or event category (denoted as 20A thru 20G) is found, then currently a registration or conference fee is paid directly to the parent organization/host organizer of the scheduled meeting and a completed registration application submitted via the Internet, US Mail, fax, etc. Upon acceptance and clearance of the payment, the applicant would be able to attend the meeting/event 20.

A mid-market company such as “Sue's Plumbing Business 10C” might have thirty (30) employees and it's planning to send ten of its top employees to a scheduled meeting or event 20 in January 2010. The company would find a suitable meeting or event 20 category and submit its registration application online via an Internet website. However, in contrast, to the usual steps, the company would first come to the financing via Securitization website 35B portal, undergo registration, and establish a linkage 35 with the parent organization/host organizer 40 website, denoted by 40A thru 40G, of the scheduled meeting/event 20. Using this created linkage, the company would then submit its credit card payment data and information, along with the meeting/event 20 registration form application to the parent organization/host organizer 40 website. Initial processing of the registration fees and conference fees submitted by Sue's Plumbing Business 10C would be performed by the financing via Securitization website 35B. However, additional processing of the credit card information, for the purposes of securitization 45 of the received conference fees and registration fees, would take place, such as aggregating the received finds into classes according to certain risks and packaging criteria that are suitable for the issued bonds and debt securities 50, denoted by 50A thru 50E, that would be sold to investors.

Referring now to FIG. 3B, the first upper section of FIG. 3B, labeled “Monthly Paid Attendees 10” indicates either 19,060 individuals or small/mid-market companies denoted by annual number of attendees 10B that have submitted their registration fee payments (on behalf of themselves or their employees) denoted by an “Amount of the Registration Fee 20” via the financing via securitization website during the months January thru December, denoted by 30 for a scheduled meeting or event. The numbers in the matrix shows, for example, that there were 205 paid attendees 40A who submitted a registration fee payment 20A in the amount of $1200 for the month of June. Likewise, the matrix shows that there were 111 paid attendees 40B and 615 paid attendees 40C who submitted registrations fee payments in an amount 20B of $1,400 and an amount 20C of $1,600 respectively, for the month of June. The combined total number of paid 10B attendees for the month of June 40 was calculated to be 931 and there were a total 10B number of 19,060 for the entire year. This total 10B number represents all individuals and/or employees of a small/mid-market company who used the financing via securitization website to submit their registration fees and/or conference fees for further linkage and transmission to the parent organization/host organizer of a scheduled meeting or event.

In the lower section, labeled “Monthly Total Amount Paid 45” is a matrix with monetary quantities showing, for example, that there was submission and clearance of $556,629 in total combined paid registration fees 50 during the month of June as a result of receiving an amount 50A of $122,975 and other sums that, being successfully collected, can be useful as collateral for the purpose of securitization. Likewise, the matrix also shows that there were paid registration fee amounts 50E and 50F submitted and cleared during the month of June giving a monthly total 50B of $66,433 and monthly total 50C amount of $369,220 respectively—these sums were successfully collected and also useful as collateral for the purpose of securitization. An annual total amount of paid funds 60 that were submitted, cleared, and successfully collected from all payment fee amount categories, is $10,477,070 as denoted by 60A and this quantity reflects the total amount of collective batch payments for the entire year that was received via the website from disparate entities.

This implementation of the present disclosure differs from the traditional current approach that is seen in the marketplace wherein an organization/host organizer that is the sponsor of a scheduled meeting or an event may conduct a targeted mass mailing by sending it to its potential attendees and expect them to send their registration and conference fees directly to the organization/host organizer. For example, by offering consumers a choice and a way to send their registration and conference fees for a scheduled meeting/event via the financing via securitization website, the website can use the “float” and its network to offer additional benefits to its customers (i.e. an individual who is not affiliated with a large organization, a small or mid-size firm, a sole proprietor, or a self-employed small business-person) that may otherwise not be available to them.

It is contemplated that the website could offer some of the following benefits: (1) purchase airline tickets from consolidators at attractive bulk rates and offer them to its network customers resulting in cost savings; (2) using the submitted customer itinerary dates, travel plans, points of origination and departure, and meeting information the ‘independent’ network customers could aggregate themselves into group(s) and this information could be provided to a meeting planner or travel agency in order to obtain group discount rates for airline, hotel, auto, or reduced conference and registration fees for a scheduled meeting, etc; and (3) provide meeting planners and hotels a website where they can list their current existing “room block shortfall” needs for any network customer who wants to volunteer to accept and stay at a particular hotel where a scheduled meeting is currently or (will soon be held at)—thus helping both a meeting planner and the hotel to address the attrition problem even though the network customer may not be affiliated with the group of attendees for that scheduled meeting/event.

The collective batching of registration and conference payments may also provide additional benefits related to the securitization process and the debt securities that are sold to investors, including:

Increased diversification and size of the receivables pool used for collateral;

Reduced risk and less dependence on a parent organization/host organizer/meeting planner related to a specific meeting occurring at a given time, place, date whose conference fees and registrations fees are used for collateral;

Provides additional sources of cash flows related to securitization of conference and registration fees by targeting the small and mid-market size companies who may not be large enough to serve as a host organization/host organizer of a meeting or an event; and

Adding an additional level of integrity to the private securitization database by allowing cross-checking of the submitted data entered by meeting planners, etc.

It is contemplated that the present disclosure may provide meeting planners with an on-line privacy protected Internet based system useful for evaluating possible financing via securitization of scheduled events and meetings that they are responsible for planning and conducting.

It is contemplated that the present disclosure may provide meeting planners with an on-line system enabling them to register scheduled events and meetings and submit pertinent financial data and non-financial information (i.e. the dates and location of a meeting, the venue site, the organization hosting the meeting, the expected number of attendees, the expected number of sponsors, the expected number of exhibitors, the amount of the registration fee per person, the amount of the conference fee per person, the amount of the exhibitor fee per exhibitor, the historical attendance record and the fees paid by the attendees during the last 3 years that the meeting occurred, etc.) for review, analysis, and evaluation that could result in the securitization of these meetings and events.

It is further contemplated that the present disclosure may process the submitted information and financial and non-financial data provided by the medical planner and offer an Internet screening service to determine if the scheduled meeting/event meets certain eligibility criteria for securitization of its meeting-related revenue and remittance payments (i.e. credit card payments, wire remittances, check payments, cash, etc).

It is further contemplated that the present disclosure may provide a firewall protected information storage and management database system that enables authorized users to access, retrieve, evaluate, analyze, and monitor financial and non-financial data related to the collateral (i.e. cash flows due to prepaid registration and conference fees, etc) that is used for securitization of bonds that have been issued in association with one or more scheduled meetings and events.

It is contemplated that the present disclosure may provide a means of using the trademark of a meeting or event as collateral for the purpose of securitization.

It is contemplated that the present disclosure may provide a means of using meeting-related income and revenue as collateral for the purpose of securitization.

It is further contemplated that the present disclosure may provide a means of using pre-paid advance hotel deposits associated with a meeting or event as collateral for the purpose of securitization.

It is further contemplated that the present disclosure may use the cost savings due to a securitization structure as a means of offsetting the potential losses incurred by a hotel and parent host organization/host organizer of a meeting that is related to using advance hotel deposits and economic attrition-clause related damages.

It is further contemplated that the present disclosure may use a securitization structure and special bankruptcy-remote, purpose entity (the “SPV”) for issuance of debt secured by the cash flows associated with the pre-paid registration and conference fee payments that are received in advance related to a scheduled meeting/event.

It is contemplated that the present disclosure may provide an individual conference organizer, event host, meeting planner, or organizer who has the primary financial responsibility for a meeting/event with the opportunity to contemplate selling its right, title, and interest in the cash flows associated with a scheduled meeting/event to the SPV and thus take advantage of the flexibility and cost-saving benefits that financing via securitization offers.

It is contemplated that the present disclosure may provide a means by which, multiple different types and categories of organizations that host meetings and events and have vastly different historical attendee records and registration and conference payment fee structures, can pool their respective rights, title, and interest in the cash flows associated with their respective scheduled meeting/event into an SPV and thus take advantage of the flexibility and cost-saving benefits that financing via securitization offers to them combined.

It is contemplated that the present disclosure may provide a means of collectively batching the conference and registration fees paid by prospective attendees from disparate entities in association with a scheduled meeting or event, wherein, those entities may include an individual who is not affiliated with a large organization, a small or mid-size firm, a sole proprietor, or a self-employed small business-person.

No element, act, or instruction used in the present application should be construed as critical or essential to the present disclosure unless explicitly described as such. In addition, as used herein, the article “a” is intended to include one or more items. Where only one item is intended, the term “one” or similar language is used.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A method for securitizing pre-paid fees for an event, comprising:
registering for at least one event through an interactive medium and a non-interactive medium;
providing financial and non-financial information relating to the at least one event;
submitting a prepaid fee as a payment to register for the at least one event;
processing the payment into at least one cash flow; and
utilizing the at least one cash flow to create a special purpose vehicle as collateral to issue and sell at least one bond.

2. The method of claim 1, wherein the financial information includes any one or more of the following: the registration fee per person for the at least one event, the exhibitor fee per exhibitor for the at least one event, and the historical registration fee of the at least one event.

3. The method of claim 1, wherein the non-financial information includes any one or more of the following: the date and location of the at least one event, the venue of the at least one event, the entity hosting the at least one event, the expected number of attendees for the at least one event, and the historical attendance record of the at least one event.

4. The method of claim 1, wherein the payment includes any one or more of the following: a credit card, a debit card, a bank wire, a money order, and cash.

5. The method of claim 1, further comprising processing event-related revenue into the cash flow payment.

6. The method of claim 5, wherein the event-related revenue is a prepaid deposit for accommodation at the location of the at least one event.

7. The method of claim 1, further comprising processing the value of a trademark relating to the at least one event into the cash flow payment.

8. The method of claim 1, further comprising providing a joint seller agreement that stipulates sharing of cost savings resulting from the special purpose vehicle.

9. The method of claim 1, wherein the special purpose vehicle is a master trust.

10. The method of claim 9, wherein the master trust is a master note trust.

11. The method of claim 9, wherein the master trust is a master owner trust.

12. The method of claim 9, wherein the master trust further includes a tranche of at least one subordinate classes for the purpose of share enhancement.

13. The method of claim 1, wherein the step of processing further includes evaluating the payment to determine if the at least one event meets certain eligibility criteria.

14. The method of claim 1, further comprising selling the right, title, and interest of the at least one cash flow into the special purpose vehicle.

15. The method of claim 1, further comprising pooling the right, title, and interest of each of the at least one events into the special purpose vehicle.

16. A method for offsetting event-related attrition based upon financial and non-financial information, comprising:
providing financial and non-financial information via an interactive medium and a non-interactive medium;
storing the financial and non-financial information in a database;
creating at least one shared interest group based upon the financial and non-financial information;
presenting each of the at least one shared interest groups to an event-related party;
inviting at least one member of the at least one shared interest group to attend the at least one event based upon the financial and non-financial information; and
offsetting event-related attrition based upon the result of inviting the at least one member.

17. The method of claim 16, wherein the non-financial information includes any one or more of the following: a name, an address, an email address, a telephone number, a home residence, current and future travel plans, hobbies, interests, pursuits, and profession.

18. The method of claim 16, wherein the event-related party includes any one or more of the following: an event planner, an event sponsor, and an event organizer.

19. The method of claim 16, wherein the event-related attrition is directed towards food and beverage consumption at the at least one event.

20. The method of claim 16, wherein the event-related attrition is directed towards fees for accommodation at the location of the at least one event.

21. A method for securitizing cash flows associated with the payment of airline tickets, comprising:
providing specified information, through an interactive medium, for air travel from a specified point of origin to a specified point of destination on a specified departure date at a specified departure time;
aggregating the specified information into at least one shared interest group;
submitting a prepaid fee as a first payment to register with the shared interest group;
presenting each of the at least one shared interest groups to the at least one airline for the right to become the scheduled airline carrier for the at least one shared interest groups;
receiving at least one offer from the at least one airline;
determining the lowest at least one offer;
accepting the lowest offer from the at least one airline;
submitting a second payment to fulfill the difference between the offer and the first payment;
processing the second payment into at least one cash flow; and
utilizing the at least one cash flow to create a special purpose vehicle as collateral to issue and sell at least one bond.
